(19) United States
(12) Patent Application Publication
(10) Pub. No.: US 2013/0170206 A1
(43) Pub. Date: Jul. 4, 2013

(54) LIGHT SOURCE DEVICE

(71) Applicants: Toshiaki Isogai, Osaka (JP); Yasuhisa Ueda, Osaka (JP); Kazushige Sugita, Hyogo (JP); Hideo Nagai, Osaka (JP); Takaari Uemoto, Osaka (JP); Masahiro Miki, Osaka (JP)

(72) Inventors: Toshiaki Isogai, Osaka (JP); Yasuhisa Ueda, Osaka (JP); Kazushige Sugita, Hyogo (JP); Hideo Nagai, Osaka (JP); Takaari Uemoto, Osaka (JP); Masahiro Miki, Osaka (JP)

(73) Assignee: PANASONIC CORPORATION, Osaka (JP)

(21) Appl. No.: 13/822,145

(22) PCT Filed: Sep. 9, 2011
(86) PCT No.: PCT/JP2011/005077

§ 371 Date: Mar. 11, 2013

(30) Foreign Application Priority Data
Oct. 12, 2010 (JP) 2010-229852
Oct. 12, 2010 (JP) 2010-229857

(51) Int. Cl. F21V 13/04; F21V 7/04

(52) U.S. Cl. CPC F21V 13/04; F21V 7/04
USPC 362/235; 362/296.01; 362/296.05; 362/296.07

(57) ABSTRACT

A light source device is provided such that light emerges mainly from the axially central section of an outer tube and is configured to minimize the risk of thermal damage to electronic components of a circuit unit. The device includes: a semiconductor light-emitting element as a light source; a circuit unit driving the semiconductor light-emitting element to emit light; and an envelope formed from an outer tube and a power connector, the envelope housing the semiconductor light-emitting element and the circuit unit. A light diffuser having a reflective outer surface to diffuse incident light is disposed at least partially in the axially central section of the outer tube. The semiconductor light-emitting element is disposed on a side of the light diffuser at which the power connector is located and in an orientation that its main emission direction points toward the light diffuser.

### TECHNICAL FIELD

The present invention relates to light source devices having a semiconductor light-emitting element, such as an LED (light-emitting diode), and in particular to an LED light source device usable as a replacement for a high-intensity discharge lamp (HID lamp).

### BACKGROUND ART

Triggered by the commercialization of high-intensity LEDs, recent years have seen an increasing prevalence of LED light source devices having an LED module as a light source. As one example, Patent Literature 1 discloses an LED lamp which is usable as a replacement for an incandescent lamp. The construction of the LED lamp disclosed is such that an LED module used as a light source as well as a circuit unit for driving the LED module is housed in an envelope formed from a globe and a base. The circuit unit is arranged at a position between the LED module and the base so as not to obstruct light emitted from the LED module.

### CITATION LIST

### Patent Literature

### Patent Literature 1

Japanese Patent Application Publication No. 2006-313717

### SUMMARY OF INVENTION

### Technical Problem

However, the above arrangement of the circuit unit means that the circuit unit is located on a heat conduction path from the LED module to the base, which involves the risk of thermal damage to electronic components of the circuit unit and thus the risk of shortening the useful life of the lamp.

Especially, in the case where an LED lamp used as a replacement for an HID lamp, which has a higher light intensity than that of an incandescent lamp, a greater number of LEDs need to be employed to obtain brightness comparable to that of the HID lamp. Naturally, heat generated by the LED module increases and thus the risk of thermal damage to electronic components becomes more prominent.

There is another setback in view of the fact that an HID lamp has almost the same light distribution as that of a point light source and light emerges mainly from an axially central section of the outer tube, which is a central section along the axis of the outer tube. That is, the LED lamp configured to emit light from the entire globe (which corresponds to the outer tube of an HID lamp) as described in Patent Literature 1 cannot achieve almost the same light distribution as the HID lamp.

The present invention is made in view of the above setbacks and aims to provide a light source device that reduces the risk of thermal damage to electronic components of the circuit unit and that shines light mainly from the axially central section of the outer tube.

### Solution to Problem

A light source device according to one aspect of the first invention includes: a semiconductor light-emitting element as a light source; a circuit unit driving the semiconductor light-emitting element to emit light; and an envelope formed from an outer tube and a power connector, the semiconductor light-emitting element and the circuit unit being housed in the envelope. The light source device further includes: a light diffuser having a reflective outer surface to diffuse incident light; and one or more supports. The light diffuser is disposed at least partially in an axially central section of the outer tube. The semiconductor light-emitting element is disposed on a side of the light diffuser at which the power connector is located and in an orientation that a main emission direction points toward the light diffuser. At least one component of the circuit unit is disposed on a side of the light diffuser opposite the semiconductor light-emitting element. The at least one component of the circuit unit and the light diffuser are held in place by being supported commonly or separately by the one or more supports.

A light source device according to another aspect of the first invention includes: two sets of one or more semiconductor light-emitting elements as a light source; a circuit unit driving the semiconductor light-emitting elements to emit light; and an envelope formed from an outer tube having two open ends and a pair of power connectors attached to each open end of the outer tube, the semiconductor light-emitting elements and the circuit unit being housed in the envelope. The light source device further includes: two light diffusers each having a reflective outer surface to diffuse incident light; and one or more supports. The light diffusers are disposed along an axial direction of the outer tube and both at least partially in an axially central section of the outer tube. Each set of one or more semiconductor light-emitting elements is disposed between one of the light diffusers and one of the power connectors that is closer to the light diffuser, and each semiconductor light-emitting element in the respective sets is oriented so that a main emission direction points toward the light diffuser. At least one component of the circuit unit is disposed between the two light diffusers. The at least one component of the circuit unit and the light diffusers are held in place by being supported commonly or separately by the one or more supports.

A light source device according to a yet another aspect of the first invention is includes: two sets of one or more semiconductor light-emitting elements as a light source; a circuit unit driving the semiconductor light-emitting elements to emit light; and an envelope formed from an outer tube having two open ends and a pair of power connectors attached to each open end of the outer tube, the semiconductor light-emitting elements and the circuit unit being housed in the envelope. The light source device further includes: a light diffuser having a reflective outer surface to diffuse incident light; and a support. At least one component of the circuit unit is disposed inside the light diffuser. The light diffuser is disposed at least partially in an axially central section of the outer tube. The sets of one or more semiconductor light-emitting elements are disposed along an axial direction of the outer tube to have the light diffuser therebetween, and each semiconductor light-emitting element in the respective sets is oriented so that a main emission direction points toward the light diffuser. The light diffuser is held in place by being supported by the support.

A light source device according to one aspect of the second invention includes: a semiconductor light-emitting element as a light source; a circuit unit driving the semiconductor light-emitting element to emit light; and an envelope formed from an outer tube and a power connector, the semiconductor light-emitting element and the circuit unit being housed in the envelope. The light source device further includes: a light diffuser that is a block of a material containing a wavelength converting material, the light diffuser converting incident light into light of a different wavelength and radially diffusing light resulting from the wavelength conversion; and one or more supports. The light diffuser is disposed at least partially in an axially central section of the outer tube. The semiconductor light-emitting element is disposed on a side of the light diffuser at which the power connector is located and in an orientation that a main emission direction points toward the light diffuser. At least one component of the circuit unit is disposed on the side of the light diffuser opposite the semiconductor light-emitting element. The at least one component of the circuit unit and the light diffuser are held in place by being supported commonly or separately by the one or more supports.

A light source device according to another aspect of the second invention includes: two sets of one or more semiconductor light-emitting elements as a light source; a circuit unit driving the semiconductor light-emitting elements to emit light; and an envelope formed from an outer tube having two open ends and a pair of power connectors attached to each open end of the outer tube, the semiconductor light-emitting elements and the circuit unit being housed in the envelope. The light source device further includes: two light diffusers each of which is a block of a material containing a wavelength converting material, each light diffuser converting incident light into light of a different wavelength and radially diffusing light resulting from the wavelength conversion; and one or more supports. The light diffusers are disposed along an axial direction of the tube and both in an axially central section of the outer tube. Each set of one or more semiconductor light-emitting elements is disposed between one of the light diffusers and one of the power connectors that is closer to the light diffuser, and each semiconductor light-emitting element in the respective sets is oriented so that a main emission direction points toward the light diffuser. At least one component of the circuit unit is disposed between the two light diffusers. The at least one component of the circuit unit and the light diffusers are held in place by being supported commonly or separately by the one or more supports.

### Advantageous Effects of Invention

In a light source device according to the first invention, the semiconductor light-emitting element is disposed on a side of the light diffuser at which the power connector is located, whereas at least one component of the circuit unit is disposed on a side of the light diffuser opposite the semiconductor light-emitting element. That is, the least one component of the circuit unit is not located on the heat conduction path between the semiconductor light-emitting element and the power connector, which ensures that the risk of thermal damage to the at least one component is lower. Therefore, the light source device has a long useful life.

In addition, the light diffuser having an outer surface where incident light is reflected off and scattered is disposed at least partially in the axially central section of the outer tube, and the semiconductor light-emitting element is oriented to have its main emission direction pointing toward the light diffuser. Owing to this construction, light emitted from the semiconductor light-emitting element is diffused at the axially central section of the outer tube. Consequently, the outer tube appears to emit light mainly from the axially central section. Therefore, the light source device presents a light distribution similar to that of an HID lamp.

In a light source device according to the second invention, the semiconductor light-emitting element is disposed on a side of the light diffuser at which the power connector is located, whereas at least one component of the circuit unit is disposed on a side of the light diffuser opposite the semiconductor light-emitting element. That is, the least one component of the circuit unit is not located on the heat conduction path between the semiconductor light-emitting element and the power connector, which ensures that the risk of thermal damage to the at least one component is lowers. Therefore, the light source device has a long useful life.

In addition, the light diffuser that radiates the incident light is disposed at least partially in the axially central section of the outer tube, whereas the semiconductor light-emitting element is oriented to have its main emission direction pointing toward the light diffuser. Owing to this construction, light emitted from the semiconductor light-emitting element is diffused at the axially central section of the outer tube. Therefore, the light source device achieves a light distribution similar to that of an HID lamp.

Furthermore, the light diffuser is made of a material containing a wavelength converting material and thus emits light resulting from wavelength conversion of the incident light. Therefore, light emerges from the outer tube is of a different color form the emission color of semiconductor light-emitting element. This construction allows the color of light to be radiated from the light diffuser to be set appropriately by adjusting the details of wavelength conversion. Therefore, by commonly using semiconductor light-emitting elements of a specific emission color, light source devices with various emission colors can be manufactured, which is an advantage for reducing the manufacturing cost.

### BRIEF DESCRIPTION OF DRAWINGS

FIG. 1 is a sectional view of a light source device according to a first embodiment of the first invention.

FIG. 2 is a sectional view taken along the arrowed line A-A of FIG. 1.

FIG. 3 is an explanatory diagram of the center of an outer tube and an axially central section of the outer tube.

FIG. 4 is a sectional view of a light source device according to a second embodiment of the first invention.

FIG. 5 is a sectional view of a light source device according to a third embodiment of the first invention.

FIG. 6 is a sectional view of a light source device according to a fourth embodiment of the first invention.

FIG. 7 is a sectional view of a light source device according to a fifth embodiment of the first invention.

FIG. 8 is a sectional view of a light source device according to a sixth embodiment of the first invention.

FIG. 9 is a sectional view of a light source device according to a first embodiment of the second invention.

FIG. 10 is a sectional view taken along the arrowed line A-A of FIG. 9.

FIG. 11 is a schematic illustration of light diffusion by a light diffuser.

FIG. 12 is a sectional view of a light source device according to a second embodiment of the second invention.

FIG. 13 is a sectional view of a light source device according to a third embodiment of the second invention.

FIG. 14 is a sectional view of a light source device according to a fourth embodiment of the second invention.

FIG. 15 is a sectional view of a light source device according to a fifth embodiment of the second invention.

### DESCRIPTION OF EMBODIMENTS

### First Invention

The following now describes light source devices according to embodiments of the first invention, with reference to the drawings.

### First Embodiment of First Invention

### [Schematic Construction]

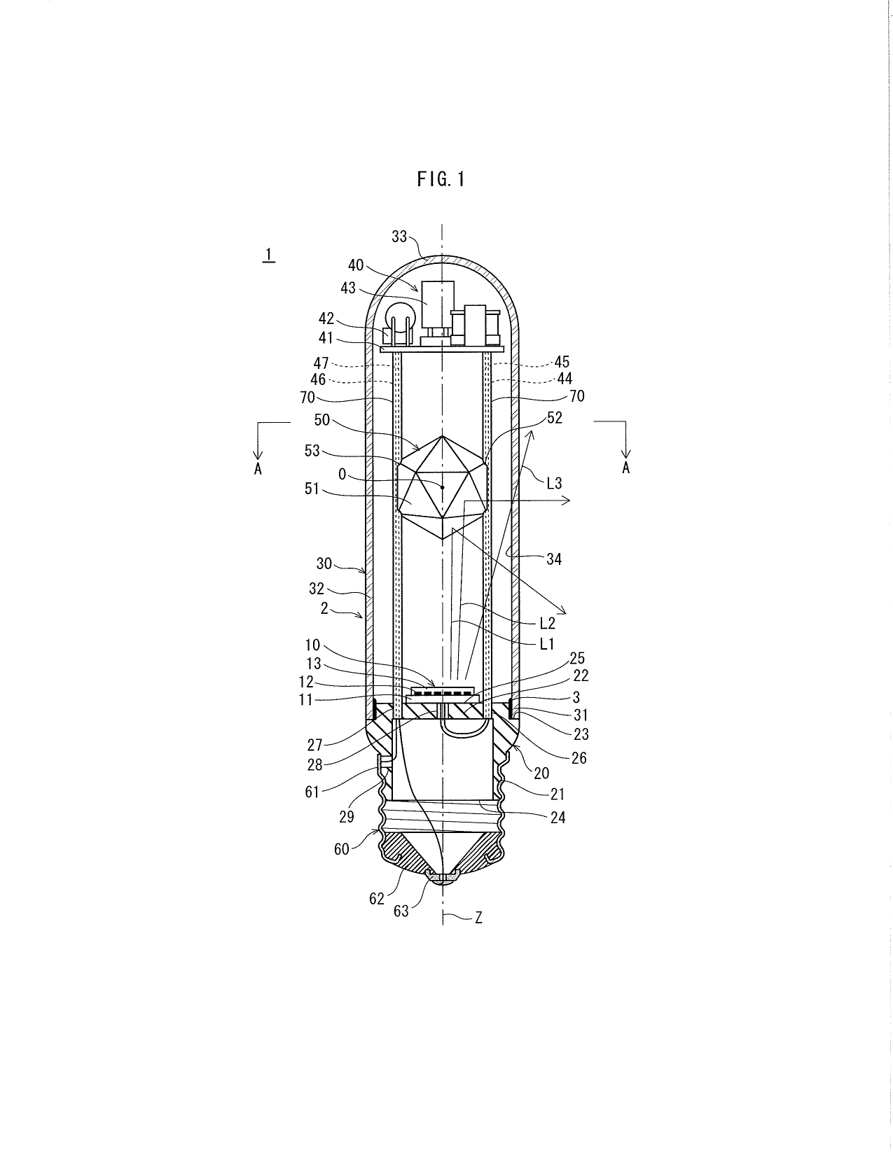

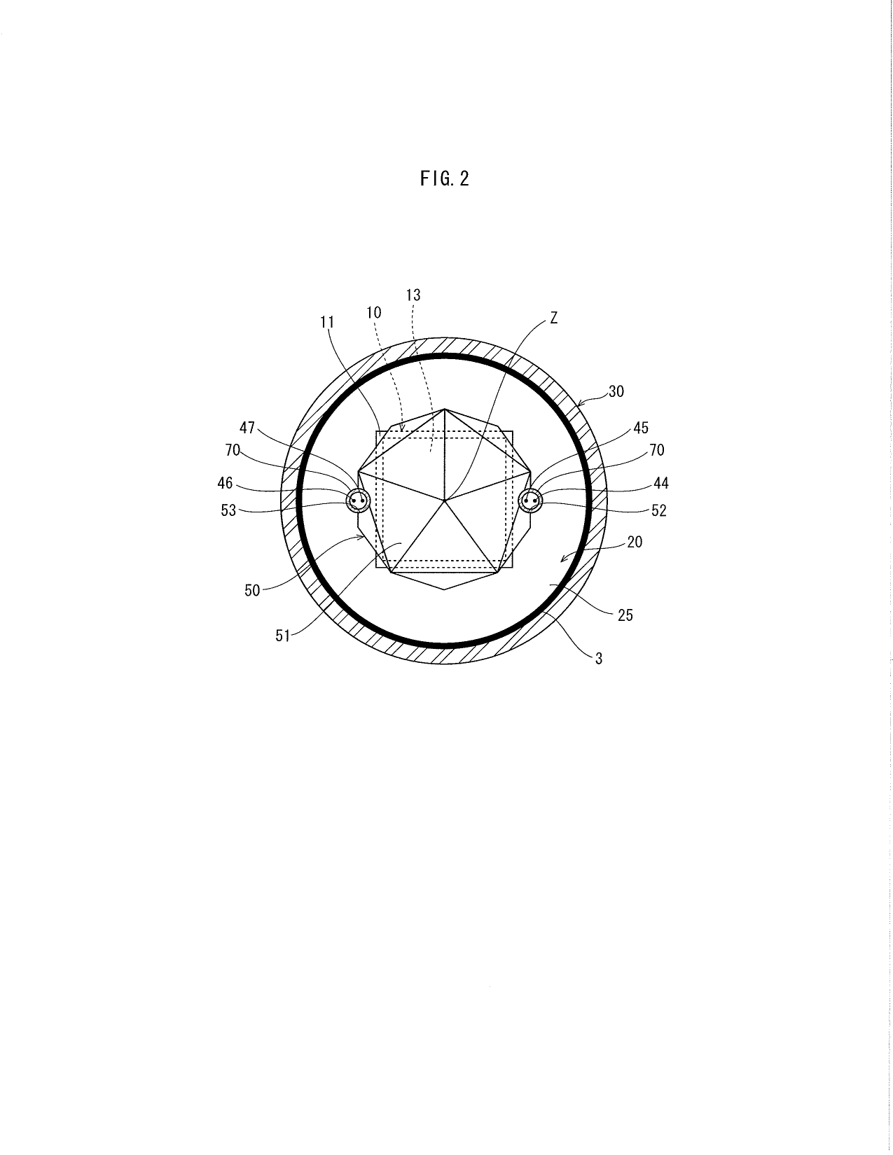

FIG. 1 is a sectional view of a light source device according to a first embodiment of the first invention, and FIG. 2 is a sectional view taken along the arrowed line A-A of FIG. 1.

As shown in FIG. 1, the light source device 1 according to the first embodiment of the first invention is an LED lamp usable as a replacement for an HID lamp. The light source device 1 includes an LED module 10 as a light source, a mount 20 on which the LED module 10 is mounted, an outer tube 30 housing the LED module 10, a circuit unit 40 for driving the LED module 10 to emit light, a light diffuser 50 for diffusing light emitted from the LED module 10, and a base 60 serving as a power connector that is electrically connected to the circuit unit 40.

In other words, the construction of the light source device 1 is such that the LED module 10 and the circuit unit 40 are housed in an envelope 2 that is composed of the mount 20, the outer tube 30, and the base 60. Disposed inside the axially central section of the outer tube 30 is a light diffuser 50 having outer surfaces 51 that reflect and diffuse light. The LED module 10 is disposed on the side of the light diffuser 50 at which the base 60 is disposed and in an orientation to have its main emission direction pointing toward the light diffuser 50. The circuit unit 40 is disposed on the side of the light diffuser 50 opposite the LED module 10. The circuit unit 40 and the light diffuser 50 are supported by a pair of supports 70.

### [Construction of Components]

### (1) LED Module

The LED module 10 includes a mounting board 11, a plurality of semiconductor light-emitting elements 12 (hereinafter, “LEDs 12”) acting as a light source and mounted on a main surface of the mounting board 11, and a sealant 13 that is mounted on the mounting board 11 in a manner to encapsulate the LEDs 12. The sealant 13 is mainly composed of a transparent material. In the case where emission light of the LEDs 12 needs to be converted into predetermined wavelengths, a wavelength converting material may be mixed into the transparent material. Examples of the transparent material include a silicone resin, and examples of the wavelength converting material include phosphor particles.

This embodiment employs the LEDs 12 that emit blue light and the sealant 13 made from a transparent material containing phosphor particles that convert blue light into yellow light. Part of blue light emitted from the LEDs 12 is converted into yellow light by the sealant 13, so that the LED module 10 emits white light resulting from mixture of unconverted blue light and converted yellow light.

### (2) Mount

The mount 20 has a tubular shape having one open end and one closed end. More specifically, the mount 20 has a cylindrical tubular portion 21 and a circular closure plate 22 integrally provided with the cylindrical tubular portion 21 to close the end that is closer to the circuit unit 40. Furthermore, the mount 20 has a recessed portion 23 annularly around the outer peripheral surface along the edge closer to the circuit unit 40. The recessed portion 23 is provided for receiving an outer peripheral edge portion 31 of the outer tube 30. The mount 20 is joined to the outer tube 30 by fitting the outer peripheral edge portion 31 into the recessed portion 23, followed by securing with adhesive 3. In addition, the base 60 is fitted over the other edge of the mount 20 (i.e., the end opposite the circuit unit 40), thereby to close that end of the cylinder portion 21.

On the main surface 25 of the closure plate 22 facing toward the circuit unit 40, the LED module 10 is disposed in a position to have the main emission direction pointing toward the light diffuser 50. The LED module 10 is secured to the mount 20 with the use of screws, adhesive, or engaging mechanism, for example. Heat generated by the LEDs 12 during lighting is conducted to the base 60 via the mount 20 and then to a lighting fixture (not illustrated) from the base 60.

### (3) Outer Tube

The outer tube 30 has a tubular shape having one open end and one closed end. More specifically, the outer tube 30 has a cylindrical tubular portion 32 and a hemispherical top portion 33 continuous with the tubular portion 32. Although the outer tube 30 is not particularly limited to a specific shape (type), the outer tube 30 in the present embodiment is a straight outer tube that models after a straight-type HID lamp. Note in addition that the outer tube 30 is not limited to a bottomed tube, which has one open and one closed end. Instated, a tube that is open at both ends may be usable.

According to the present embodiment, the outer tube 30 is colorless transparent and made of a transparent material, such as glass, ceramics, resin, or the like. Light incident on the inner surface 34 of the outer tube 30 passes through the outer tube 30 to the outside without being diffused. Note that the outer tube 30 is not necessarily colorless transparent and may be colored transparent instead. In addition, the inner surface 34 of the outer tube 30 may be processed with silica, white pigment, or the like to impart the property of diffusing light emitted from the LED module 10.

### (4) Circuit Unit

The circuit unit 40 includes a circular circuit board 41 and electronic components 42 and 43 mounted on the circuit board 41. Note that the electronic components 42 and 43 are mounted on the main surface of the circuit board 41 that faces away from the base 60. Note that the figure only shows some of electronic components with reference signs, and there are other electronic components to which no reference signs have been applied.

The circuit unit 40 is disposed inside the top portion 33 of the outer tube 30 in the state being supported by the pair of supports 70. To fix the circuit board 41 to the pair of supports 70, one end of each support 70 is bonded to the circuit board 41. Note that the method for fixing the circuit unit 40 to the supports 70 is not limited to the one described above, and screws or an engaging mechanism may be used.

As above, the circuit unit 40 is located inside the top portion 33 of the outer tube 30, which is a position farthest away from the LED module 10. Consequently, heat from the LEDs 12 is less likely to be conducted to the circuit unit 40 so that the risk of thermal damage to the electronic components 42 and 43 of the circuit unit 40 is lower.

As shown in FIG. 1, the circuit board 41 is oriented to have the main surface perpendicular to the lamp axis Z, and the top portion 33 of the outer tube 30 is hemispherical in shape. In this case, it is preferable to arrange the electronic component 43, which is relatively tall, at a position closer to the lamp axis Z where the space between the circuit board 41 and the outer tube 30 is relatively wide and arrange the electronic component 42, which is relatively short, at a position farther from the lamp axis Z where the space between the circuit board 41 and the outer tube 30 is relatively narrow. This arrangement allows the circuit unit 40 to be fit within the top portion 33 of the outer tube 30 more compactly. As a consequence, the circuit unit 40 is ensured to be farther away from the LED module 10, which is effective to prevent thermal damage to the electronic components 42 and 43 of the circuit unit 40.

### (5) Light Diffuser

The light diffuser 50 is a block-shaped member disposed in the outer tube 30. At least a region of the outer surfaces 51 is a reflective surface where incident light is reflected off and diffused. According to the present embodiment, the light diffuser 50 has the outer shape of a regular icosahedron and the entire outer surfaces 51 are reflective surfaces.

Note that the outer shape of the light diffuser 50 is not limited to a regular icosahedron as long as the outer surfaces 51 of the light diffuser 50 reflect and scatter light. For example, the light diffuser 50 may have the shape of a regular polyhedron other than a regular icosahedron, such as a regular tetrahedron, a regular hexahedron, a regular octahedron, or a regular dodecahedron.

Further, the outer shape of the light diffuser 50 is not limited to a regular polyhedron. Alternatively, the light diffuser 50 may have the shape of a semi-regular polyhedron, such as a truncated tetrahedron, a truncated hexahedron, a truncated octahedron, a truncated dodecahedron, a truncated icosahedron, a rhombicosidodecahedron, a rhombitruncated cuboctahedron, a rhombitruncated icosidodecahedron, a rhombicubooctahedron, a snub cube or a snub dodecahedron.

Still further, the outer shape of the light diffuser 50 is not limited to a semi-regular polyhedron. Alternatively, the light diffuser 50 may have the shape of a regular polyhedron, such as a regular tetrahedron, a regular hexahedron, a regular octahedron, a regular dodecahedron or a regular icosahedron. Still further, the light diffuser 50 may alternatively have the shape of a quasi-regular polyhedron, such as a cuboctahedron, an icosidiodecaherdon, a dodecadodecahedron, a great icosidodecahedron, a small ditrigonal icosidodecahedron, a ditrigonal dodecadodecahedron, a great ditrigonal icosidodecahedron, a tetrahemihexahedron, an octahemioctahedron, a cubohemioctahedron, or a small icosihemidodecahedron.

Still further, the light diffuser 50 may alternatively have the shape of a regular star polyhedron, such as a small stellated dodecahedron, a great dodecahedron, a great stellated dodecahedron, or a great icosahedron. Still further, the light diffuser 50 may alternatively have the shape of a uniform polyhedron, such as a small cubicuboctahedron, a great cubicuboctahedron, a cubitruncated cuboctahedron, a uniform great rhombicuboctahedron, a small rhombihexahedron, a great truncated cuboctahedron, a great rhombihexahedron, a small icosicosidodecahedron, a small snub icosicosidodecahedron, a small dodecicosidodecahedron, a truncated great dodecahedron, a rhombidodecadodecahedron, a truncated great icosahedron, a small stellated truncated dodecahedron, a great stellated truncated dodecahedron, a great dirhombicosidodecahedron, or a great disnub dirhombidodecahedron.

Still further, the light diffuser 50 may alternatively have the shape of an Archimedean dual, a deltahedron, a Johnson solid, a stellation, a zonohedron, a parallelohedron, a rhombohedron, a polyhedral compound, a compound, a perforated polyhedron, Leonardo da Vinci's polyhedra, a ring of regular tetrahedra, or a regular skew polyhedron.

Yet, in order ensure that the light diffuser 50 reflects light uniformly in all directions, it is preferable that the outer shape of the light diffuser 50 is a regular polyhedron, a semi-regular polyhedron, a quasi-regular polyhedron, or a sphere. In addition, in order to ensure that the light diffuser 50 reflects light in various directions, it is preferable that the outer shape of the light diffuser 50 is a sphere or polyhedron having surface(s) suitable for achieving the desired light distribution. It is not necessary that the entire outer surfaces 51 of the light diffuser 50 are reflective. It is applicable that only part of the outer surfaces 51 is reflective. For example, of the outer surfaces of the light diffuser 50, only a region facing toward the LED module 10 may be reflective.

The light diffuser 50 may be formed, for example, of a resin material, such as polycarbonate, and the entire outer surfaces 51 may be processed to have mirror finished surfaces. Note that the material for the light diffuser 50 is not limited to a resin and may alternatively be glass or metal such as aluminum. In addition, the light diffuser 50 may be solid as in the present embodiment or hollow for achieving the weight reduction.

The light diffuser 50 is disposed in the outer tube 30 at a position between the LED module 10 and the circuit unit 40, and the main emission direction is directed toward the light diffuser 50. Most of light emitted from the LED module 10 reaches the outer surfaces 51 of the light diffuser 50, where the light is reflected off to be scattered in various directions.

As shown in FIG. 2, the sealant 13 of the LED module 10 is located directly below the light diffuser 50 in plan view of the light source device 1 (i.e., when the light source device 1 is seen from the direction opposite the base 60 along the lamp axis Z, i.e., when the light source device 1 is seen from the top to the bottom of FIG. 2). Therefore, the sealant 13 is completely hidden below the light diffuser 50 in plan view of the light source device 1. This arrangement ensures that light emitted from the LED module 10 in the main emission direction (in the directly upward direction in FIG. 2) efficiency reaches the outer surfaces 51 of the light diffuser 50. In addition, none of light emitted from the LED module 10 in the main emission direction reaches the circuit unit 40 as it is blocked by the light diffuser 50, so that absorption of light by the circuit unit 40 is prevented.

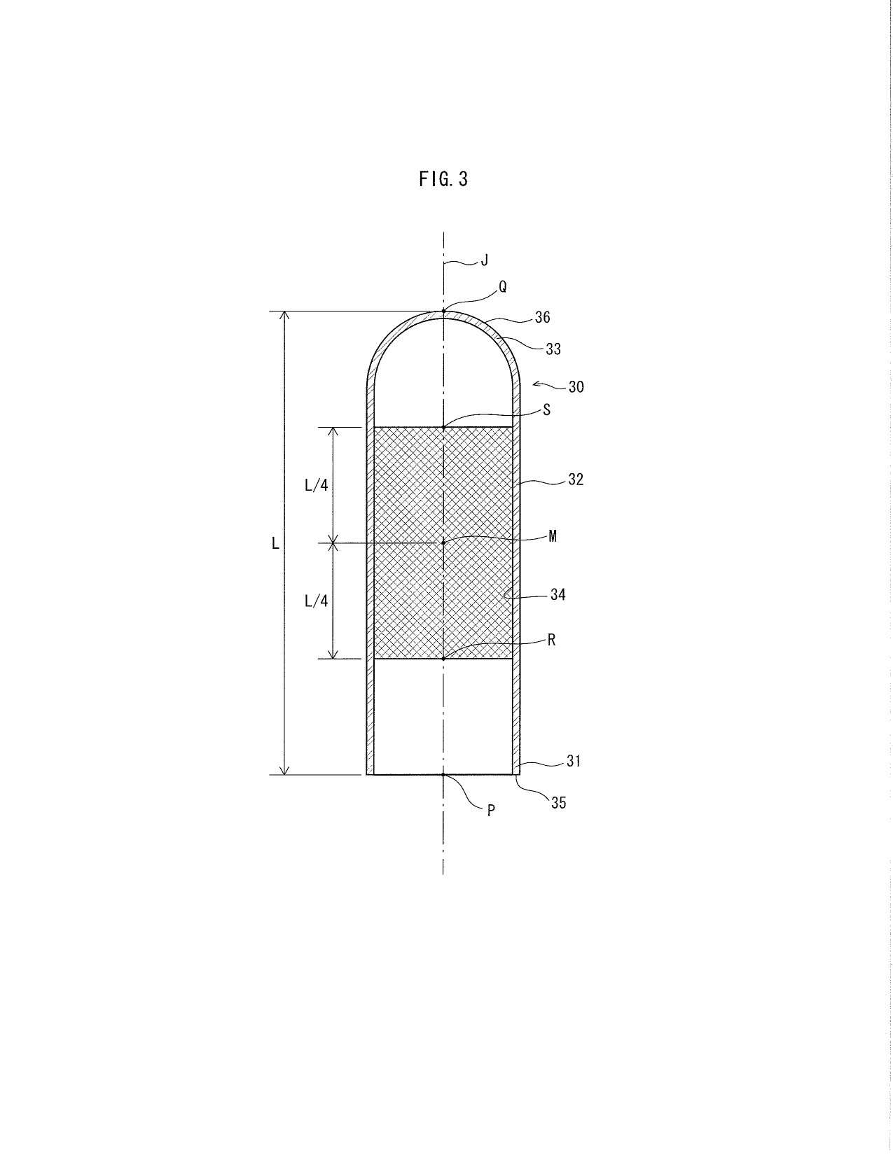

FIG. 3 is an explanatory diagram of the center of the outer tube and an axially central section of the outer tube. The light diffuser 50 is disposed in the axially central section of the outer tube 30 so that the center O of the light diffuser 50 (the center of the regular icosahedron in the present embodiment, see FIG. 1) coincides with the center M of the outer tube 30 (see FIG. 3). The center O of the light diffuser 50 is also the optical center of the light source device 1. In the present embodiment, the lamp axis Z is in alignment with the tube axis J of the outer tube 30.

The center M of the outer tube 30 is defined to be a midpoint between Points P and Q, where P denotes an intersection point of a plane containing the open end 35 of the outer tube 30 with the tube axis J, and Q denotes an intersection point of the outer surface 36 of the top portion 33 of the outer tube 30 with the tube axis J. In addition, the axially central section of the outer tube 30 refers to a section between Points R and S (crosshatched area in FIG. 3), where L denotes the length of the outer tube 30 (equal to the distance between Points P and Q), and each of Points R and S is away from the center M along the tube axis J toward Points P and Q, respectively, by the distance equal to 25% of the distance L (i.e., L/4).

Note that the center O of the light diffuser 50 is not required to coincide with the center M of the outer tube 30. Yet, the positional relation should preferably satisfy the condition that at least the center O of the light diffuser 50 is located within the axially central section of the outer tube 30, and more preferably satisfy the condition that the light diffuser 50 is located entirely within the axially central section of the outer tube 30.

Referring back to FIG. 1, the light diffuser 50 is held in place between the pair of supports 70 by being supported by the supports 70. The light diffuser 50 has two engaging grooves 52 and 53 formed in the outer surfaces 51. The engaging grooves 52 and 53 are for engagement with the supports 70 and extend in a direction along the lamp axis Z. In the state where the supports 70 are received within the engaging grooves 52 and 53, adhesive is poured into the grooves 52 and 53. As a result, the light diffuser 50 is secured to the pair of supports 70. As above, the light diffuser 50 is secured at two locations using both the engaging structure and adhesive. Therefore, the risk of accidental detachment of the light diffuser 50 from the pair of supports 70 is little. Note that the method to fix the light diffuser 50 to the pair of supports 70 is not limited to that described above. Alternatively, the light diffuser 50 may be fixed to the pair of supports with screws, for example.

### (6) Base

The base 60 is for receiving power supply from the socket of a lighting fixture when the light source device 1 is attached to the lighting fixture and driven. Although the base 60 is not limited to any specific type an E26 base, which is a so-called Edison base, is used in this embodiment. The base 60 has a shell portion 61 and an eyelet portion 63. The shell portion 61 is tubular in shape and has an externally threaded circumferential surface, whereas the eyelet portion 63 is attached to the shell portion 61 via an insulating material 62.

### (7) Supports

Each support 70 is a tubular member having a shape of a cylindrical tube and being made of glass, metal or resin, for example. One end of each support is fixed to the circuit unit 40, and the other end is inserted and bonded in a corresponding one of through holes 26 and 27 formed in the closure plate 22 of the mount 20.

As shown in FIG. 2, the supports 70 are disposed to face each other across the LED module 10 with the lamp axis Z in the middle. This arrangement helps to ensure that that the pair of supports 70 do not block light emitted from the LED module 10 and that the circuit unit 40 and the light diffuser 50 are supported in a well-balanced state. Note, in addition, that the number of supports 70 is not limited to two, and only one support or three or more supports may be used. Also, although the circuit unit 40 and the light diffuser 50 are commonly supported by the same supports 70 according to the present embodiment, the circuit unit 40 and the light diffuser 50 may be separately supported by different supports.

The supports 70 may be made of a transparent material, which further helps to avoid light emitted by the LEDs 12 being blocked by the supports 70. Alternatively, the supports 70 may be made of a non-transparent material. In such a case, the outer surfaces of the supports 70 may be processed to have a mirror finish to improve reflectivity, which helps to ensure that the supports 70 do not absorb light emitted by the LEDs 12.

Instead of the shape of a cylindrical tube, each support 70 may be a tubular member of any other shape such as a prismatic shape. In addition, each support 70 may be a solid cylinder or solid prism instead of a tubular (i.e., hollow) member. When the supports 70 are solid, it may be possible to wind electrical wiring lines 44-47, which will be described later, around the respective supports 70 or arrange the wiring lines 44-47 to extend along the respective supports 70.

An output terminal of the circuit unit 40 is electrically connected to an input terminal of the LED module 10 via the wiring lines 44 and 45. The wiring lines 44 and 45 extending from the circuit unit 40 pass through the interior passage of one of the supports 70 to reach a location closer to the base 60 beyond the closure plate 22 of the mount 20. The wiring lines 44 and 45 are then turned back to pass through a through hole 28 formed in the closure plate 22 and connected to the LED module 10.

The input terminals of the circuit unit 40 are electrically connected to the base 60 via the wiring lines 46 and 47. The wiring lines 46 and 47 extending from the circuit unit 40 pass through the interior passage of the other one of the supports 70 to reach a location closer to the base 60 beyond the closure plate 22 of the mount 20. The wiring line 46 further extends to pass through a through hole 29 formed in the tubular member 21 of the mount 20 and is connected to the shell portion 61 of the base 60. On the other hand, the wiring line 47 further extends through an open end 24 of the tubular member 21 facing toward the base 60 and is connected to the eyelet portion 63 of the base 60.

Note that the electrical wiring lines 44-47 used in this embodiment are insulated leads.

Alternatively to the supports 70, the wiring lines 44-47 of a larger diameter may be used to support the circuit unit 40 and the light diffuser 50. In that case, the circuit unit 40 and the reflecting mirror 50 are secured to the wiring lines 44-47. In the manner described above, the wiring lines 44-47 may be used as supports.

[Path of Light Emitted from LEDs]

According to the present embodiment, the entire outer surfaces 51 of the light diffuser 50 are reflective and light emitted from the LED module 10 is reflected and thus scattered in various directions by the outer surfaces 51 (in the present embodiment, the light diffuser 50 is a regular icosahedron and therefore has 20 outer surfaces).

For example, a ray of light L1 emitted from the LED module 10 toward the circuit unit 40 is reflected by one of the outer surfaces 51 of the light diffuser 50 and the reflected light travels toward the base 60. In addition, for example, a ray of light L2 emitted from the LED module 10 toward the circuit unit 40 at a different angle is reflected by another one of the outer surfaces 51 of the light diffuser 50 and the reflected light travels in a direction perpendicular to the lamp axis Z. In addition, for example, a ray of light L3 emitted from the LED module 10 in a direction where the light diffuser 50 is not located passes by the light diffuser 50 without hitting the outer surfaces 51 of the light diffuser 50 and thus keeps traveling in a direction away from the base 60.

As described above, the rays of light L1-L3 travels in different directions all exit to the outside after passing through the outer tube 30. At this time, the rays of light L1-L3 travel radially from the light diffuser 50 as if those rays of light L1-L3 were emitted from the light diffuser 50. Therefore, the light distribution similar to that of an HID lamp is obtained.

### [Heat Dissipation Path]

According to the present embodiment, the circuit unit 40 is disposed at the side of the light diffuser 50 opposite the LED module 10. This construction permits a greater number of LEDs 12 to be employed or a higher electric current to be input. When a greater number of LEDs 12 is employed or a higher electric current is input to the LEDs 12, the amount of heat generated by the LED module 10 increases. Yet, since the circuit unit 40 is not located between the LED module 10 and the base 60, the distance between the LED module 10 and the base 60 is relatively short, which leads to more effective heat transfer from the LED module 10 to the base 60.

In addition, even if heat generated by the LEDs 12 remains in the mount 20 to elevated the temperature of the mount 20, heat load to be imposed on the circuit unit 40 is small because the circuit unit 40 is located at the side opposite the base 60 with respect to the LED module 10 and housed inside the outer tube 30. Therefore, it is not necessary to provide heat dissipating means, such as a heat sink, for lowering the temperature of the mount 20 and thus upsizing of the light source device 1 is avoided.

In addition, since the circuit unit 40 is housed in the outer tube 30, it is no longer necessary to secure space for accommodating the circuit unit 40 between the LED module 10 and the base 60. Consequently, the mount 20 of a smaller size may be usable. Note that the size reduction of the mount 20 results in that the temperature of the mount 20 will be higher. Yet, since the circuit unit 40 is not located between the LED module 10 and the base 60, little effect is imposed on the circuit unit 40.

### [Supplemental]

According to the present embodiment, the circuit unit 40 is housed in the outer tube 30. Therefore, there is no need to secure space for accommodating the circuit unit 40 between the mount 20 and the base 60. This makes it possible to reduce the size of the mount 20, which in turn makes it possible to form the light source device 1 in a shape and size similar to that of an HID lamp. The above advantages help to improve the percentage of the light source devices 1 according to the present embodiment to be fit to existing lighting fixtures. In addition, by reducing the size of the mount 20, the size of the outer tube 30 can be increased without increasing the overall size of the light source device 1. Therefore, a sufficient space is secured inside the outer tube 30 for accommodating the circuit unit 40.

### Second Embodiment of First Invention

A light source device according to a second embodiment of the first invention differs from the light source device 1 according to the first embodiment of the first invention in that a lens is provided between the LED module and the light diffuser in order to gather emission light of the LED module to the light diffuser. Other than that, the construction of the light source device of this embodiment is basically the same as that of the light source device 1 according to the first embodiment of the first invention. The following description is therefore given only of the difference, and a description of other components is omitted. Note that the same components as those of the first embodiment of the first invention are designated by the same reference signs.

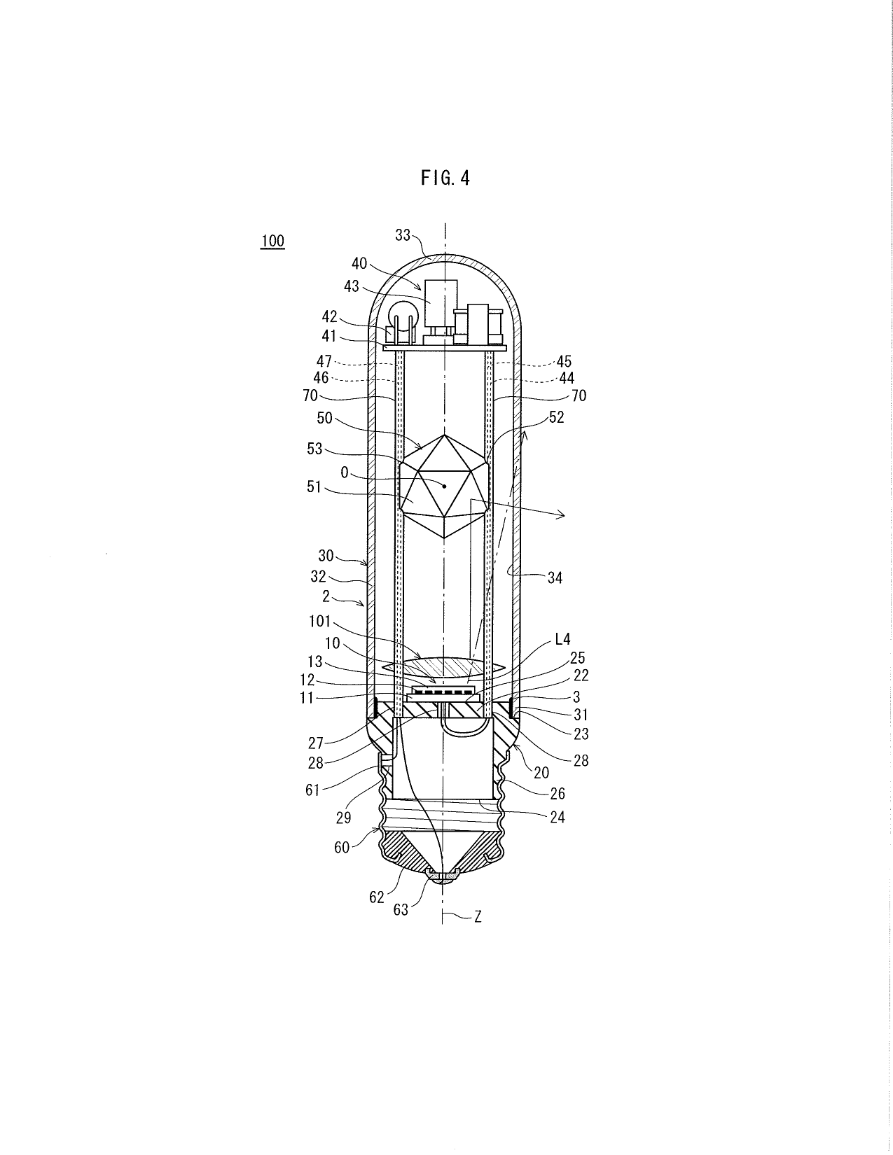

FIG. 4 is a sectional view of a light source device according to the second embodiment of the first invention. As shown in FIG. 4, a light source device 100 according to the second embodiment of the first invention includes an LED module 10, a mount 20, an outer tube 30, a circuit unit 40, a light diffuser 50, a base 60 and a pair of supports 70. In addition, a lens 101 is provided between the LED module 10 and the light diffuser 50.

The lens 101 is for gathering emission light of the LED module 10 to the outer surfaces 51 of the light diffuser 50. In the present embodiment, a biconvex lens is used. The lens 101 collimates light from the LED module 10 into parallel rays of light that travels along the lamp axis Z. Note that the lens 101 is not limited to a biconvex lens and may alternatively be a plano-convex lens. Furthermore, the lens 101 is not limited to a lens that collimates light from the LED module 10 into parallel light that travels along the amp axis Z. Any lens is usable as long as it collects light onto the outer surfaces 51 of the light diffuser 50.

According to the construction of the above embodiment, a ray of light L4 that is emitted at an angle not toward any of the outer surfaces 51 of the light diffuser 50 as indicated by the chain double-dashed line changes the direction of travel by passing through the lens 101 and falls on the outer surfaces 51 of the light diffuser 50. By the presence of the lens 101, a greater amount of light can be gathered onto the light diffuser 50 and thus a greater amount of light is scattered by the outer surfaces 51 of the light diffuser 50. In addition, since the amount of light traveling toward the base 60 increases, light is efficiency collected, for example, to a reflecting mirror (not illustrated) of a lighting fixture.

### Third Embodiment of First Invention

A light source device according to a third embodiment of the first invention differs from the light source device 1 according to the first embodiment of the first invention in that a concave reflecting mirror is provided between the LED module and the base. The concave reflecting mirror has a concave reflective surface facing toward the light diffuser, so that light emitted from the LED module is gathered to the light diffuser. Other than that, the construction of the light source device according to this embodiment is basically the same as that of the light source device 1 according to the first embodiment of the first invention. The following description is therefore given only of the difference, and a description of other components is omitted. Note that the same components as those of the first embodiment of the first invention are designated by the same reference signs.

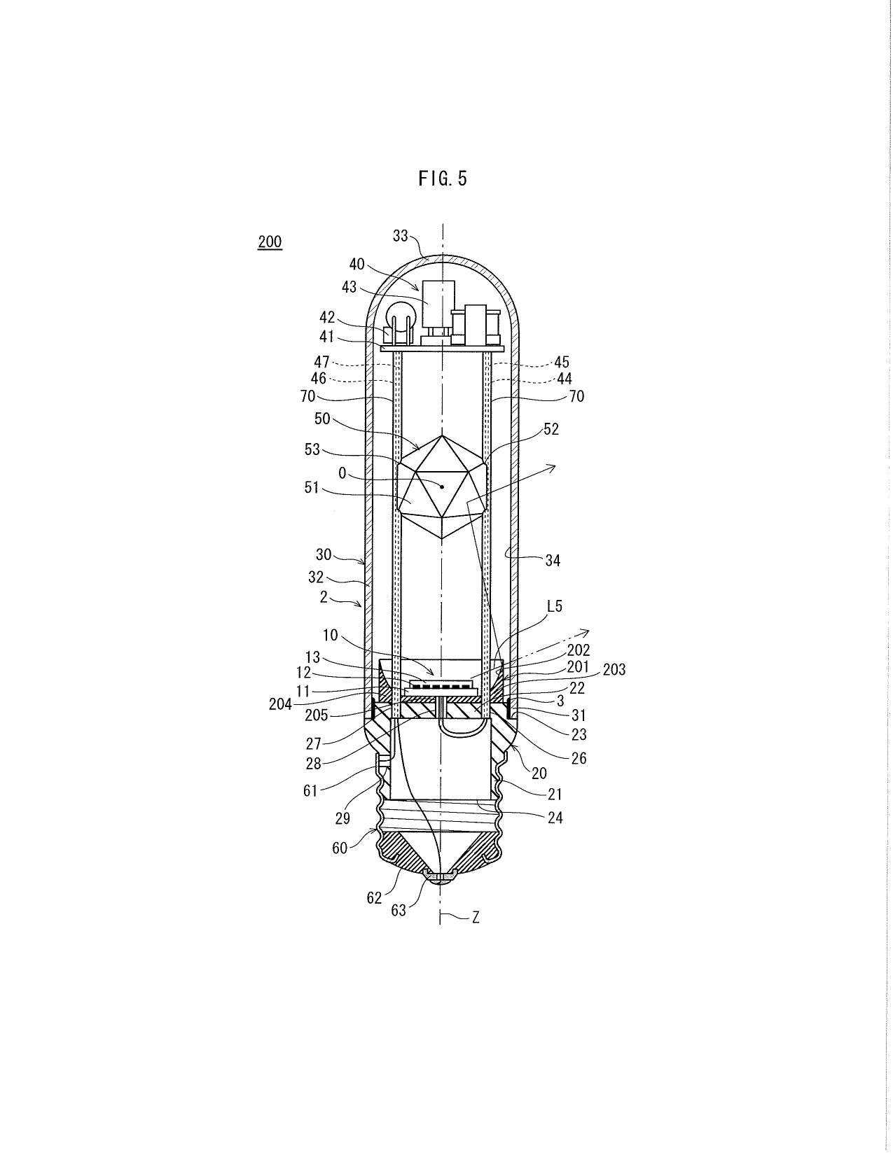

FIG. 5 is a sectional view of a light source device according to the third embodiment of the first invention. As shown in FIG. 5, a light source device 200 according to the third embodiment of the first invention includes an LED module 10, a mount 20, an outer tube 30, a circuit unit 40, a light diffuser 50, a base 60 and a pair of supports 70. In addition, a concave reflecting mirror 201 is provided between the LED module 10 and the base 60.

The concave reflecting mirror 201 has a concave reflective surface 202 and is disposed on the main surface 25, of the closure plate 22 of the mount 202, facing toward the circuit unit 40 in such an orientation to have the reflective surface 202 facing toward the light diffuser 50. The LED module 10 is centrally disposed on the reflective surface 202. Light emitted from the LED module 10 and incident on the reflective surface 202 is collected to the outer surfaces 51 of the light diffuser 50.

The concave reflecting mirror 201 has through holes 203 and 204 at positions corresponding to the through holes 26 and 27 in the mount 20, for allowing the supports 70 to pass through. In addition, the concave reflecting mirror 201 also has a through hole 205 at a position corresponding to the through hole 28 in the mount 20, for allowing wiring lines 44 and 45 to pass through.

With the construction of the present embodiment, a ray of light L5 emitted in a lateral direction indicated by the chain double-dashed line (i.e., in the direction perpendicular to or nearly perpendicular to the main emission direction) is changed the direction of travel by the reflective surface 202 of the concave reflecting mirror 201 and falls on the outer surfaces 51 of the light diffuser 50. Therefore, more light is gathered onto the light diffuser 50 and more light is scattered by the outer surfaces 51 of the light diffuser 50. In addition, light that would otherwise exit the outer tube 30 from the open end portion 31 as indicated by the chain double-dashed line is collected to the light diffuser 50 and is ultimately released from the axially central section of the outer tube 30.

### Fourth Embodiment of First Invention

A light source device according to a fourth embodiment of the first invention differs from the light source device 1 according to the first embodiment of the first invention in that a concave reflecting mirror is disposed between the light diffuser and the circuit unit. The concave reflecting mirror has a concave reflective surface facing toward the light diffuser, so that light emitted from the LED module is gathered to the light diffuser. Other than that, the construction of the light source device of this embodiment is basically the same as that of the light source device 1 according to the first embodiment of the first invention. The following description is therefore given only of the difference, and a description of other components is omitted. Note that the same components as those of the first embodiment of the first invention are designated by the same reference signs.

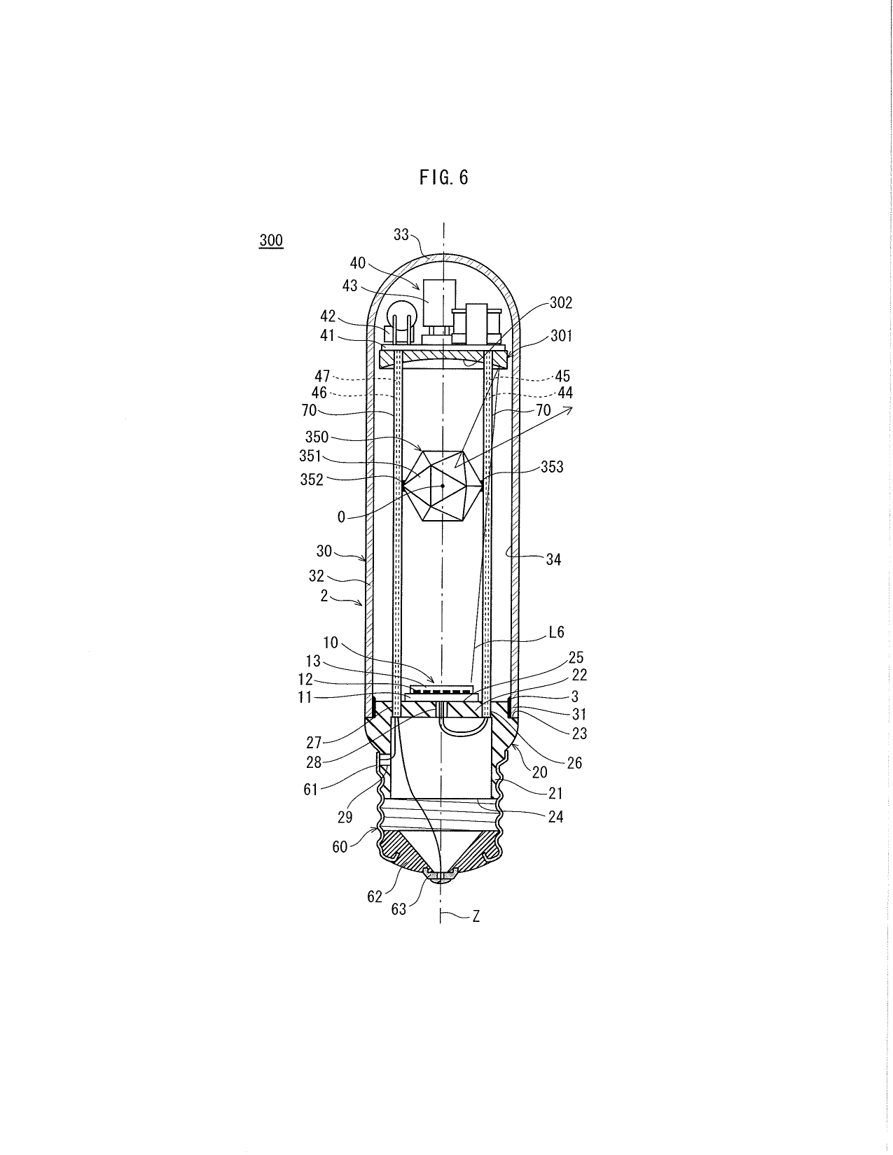

FIG. 6 is a sectional view of a light source device according to the fourth embodiment of the first invention. As shown in FIG. 6, a light source device 300 according to the fourth embodiment of the first invention includes an LED module 10, a mount 20, an outer tube 30, a circuit unit 40, a light diffuser 350, a base 60 and a pair of supports 70. In addition, a concave reflecting mirror 301 is provided between the light diffuser 350 and the circuit unit 40.

The concave reflecting mirror 301 has a concave reflective surface 302 and is fixed by adhesive to the main surface, of the circuit board 41 of the circuit unit 40, facing toward the base 60 in such an orientation to have the reflective surface 302 facing toward the light diffuser 350. The concave reflecting mirror 301 has through holes 303 and 304 for allowing the supports 70 to pass through. Each support 70 passes through a corresponding one of the through holes 303 and 304 and is bonded to the circuit board 41 of the circuit unit 40.

When seen from the direction along the lamp axis Z, the reflective surface 302 is larger than the circuit board 41 of the circuit unit 40. Therefore, a ray of light L6 emitted from the LED module 10 toward the circuit board 41 is reflected off the reflective surface 302 to fall on the outer surfaces 351 of the light diffuser 50.

The light diffuser 350 is one size smaller than the light diffuser 50 according to the first embodiment of the first invention for allowing part of light emitted from the LED module 10 to reach the reflective surface 302 of the concave reflecting mirror 301 without hitting the outer surfaces 351 of the light diffuser 350. Different from the light diffuser 50 according to the first embodiment of the first invention, the light diffuser 350 is not provided with the engaging grooves 52 and 53. Instead, the light diffuser 350 is fixed to the pair of supports 70 with adhesive 352 and 353 at two locations on the outer surfaces 351.

According to the construction of the present embodiment, a ray of light L6 that is emitted from the LED module 10 toward the reflective surface 302 of the concave reflecting mirror 301 travels without being reflected off the outer surfaces 351 of the light diffuser 350 and is reflected off the reflective surface 302. The thus reflected light falls on one of the outer surfaces 351 of the light diffuser 350 facing in a direction away from the LED module 10. As a consequence, of the outer surfaces 351 of the light diffuser 350, those facing in a direction away from the LED module 10 are caused to reflect extra light, which achieves light radially disused from the light diffuser 50. That is, a light distribution even more similar to that of an HID lamp is achieved.

### Fifth Embodiment of First Invention

A light source device according to a fifth embodiment of the first invention significantly differs from the light source device 1 according to the first embodiment of the first invention in that the light source device is of a bi-base type and that two light diffusers are disposed with a circuit unit located inbetween. The following description focuses on points greatly different from the light source device 1 according to the first embodiment of the first invention, whereas a description of common points is omitted or given only briefly.

### [Schematic Construction]

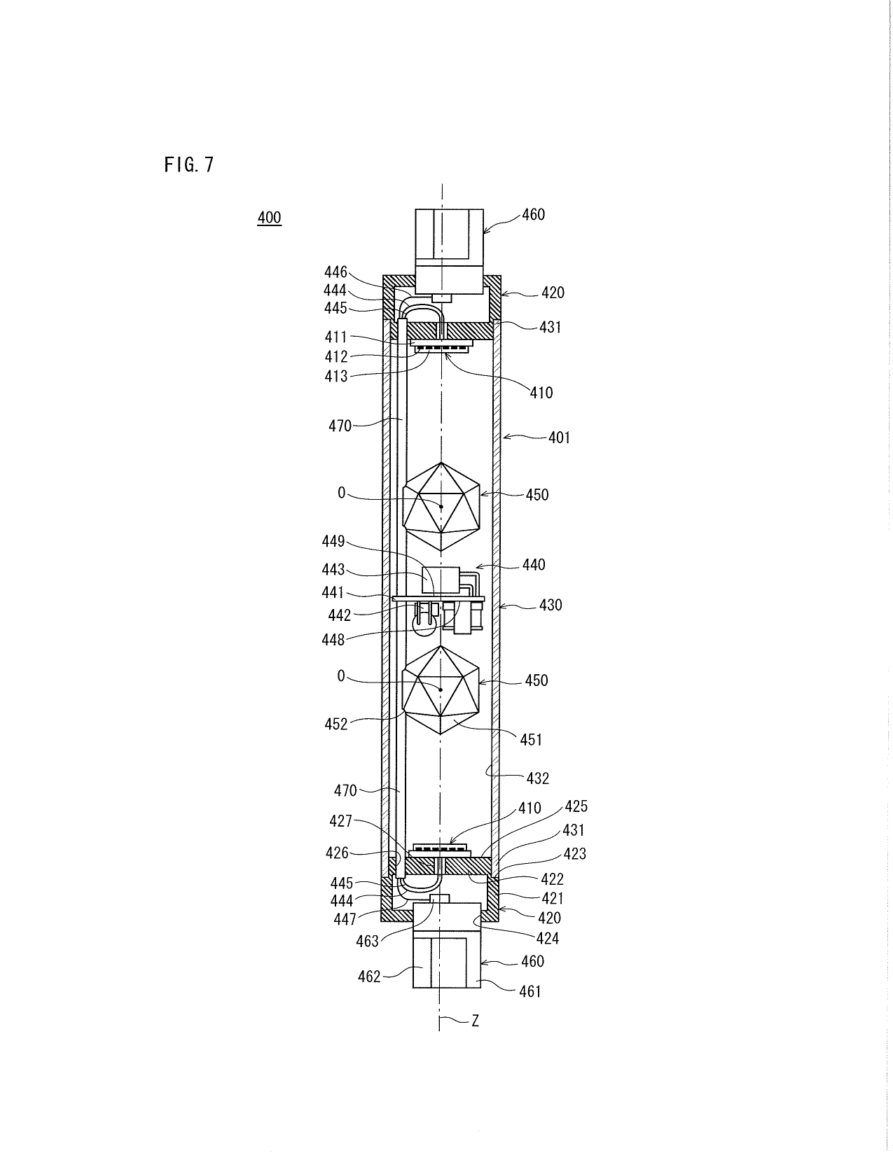

FIG. 7 is a sectional view of a light source device according to the fifth embodiment of the first invention. As shown in FIG. 7, the light source device 400 according to the fifth embodiment of the first invention is an LED lamp usable as a replacement for a bi-base HID lamp and includes a pair of LED modules 410 serving as a light source, a pair of mounts 420 each having one of the LED modules 410 mounted thereon, an outer tube 430 in which the mounts 420 are disposed one at each end of the outer tube 430, a circuit unit 440 for driving the LED module 410, a pair of light diffusers 450 each disposed in an axially opposite relation with one of the LED modules 410, and a pair of bases 460 serving as a pair of power connectors that are electrically connected to the circuit unit 440.

In other words, the construction of the light source device 400 is such that the pair of LED modules 410, each of which serves as a light source, and the circuit unit 440 for driving the LED modules 410 are housed in an envelope 401. The envelope 401 is constructed from the outer tube 430, which is a hollow tube having both ends open, and the pair of bases 460 disposed one at each end of the outer tube 430. In the axially central section of the outer tube 430, the two light diffusers 450 each having outer surfaces 451 for scattering incident light are disposed along the direction of the tube axis. Each LED module 410 is disposed at a position between one of the light diffusers 450 and one of the bases 460 closer to the light diffuser 450, in such an orientation to have the main emission direction pointing toward the light diffuser 450. The circuit unit 440 is disposed between the two light diffusers 450, and the circuit unit 440 as well as the light diffusers 450 is supported by a pair of supports 470.

### [Construction of Components]

### (1) LED Modules

The construction of each LED module 410 is substantially identical to the LED module 10 according to the first embodiment of the first invention. That is, each LED module 410 has a mounting board 411, a plurality of LEDs (a set of LEDs) 412 mounted as a light source on a surface of the mounting board 411, and a sealant 413 disposed on the mounting board 411 to encapsulate the LEDs 412. Similarly to the above embodiment, the sealant 413 according to the present embodiment is made from a transparent material containing phosphor particles for wavelength conversion from blue light to yellow light. Therefore, each LED module 410 emits white light.

### (2) Mount

Each mount 420 has a tubular shape having one open end and one closed end. Each mount 420 includes a hollow cylinder portion 421 having both ends open and a circular closure plate 422. The circular closure plate 422 is an integral continuation of the cylinder portion 421 and closes one of the open ends closer to the circuit unit 440. Each mount 420 has a recessed portion 423 annularly around the outer peripheral surface along the edge closer to the circuit unit 440. The recessed portion 423 is provided for receiving an outer peripheral edge portion 431 of the outer tube 430. The pair of mounts 420 is joined one at each end of the outer tube 430 by fitting the outer peripheral edge portion 431 into the recessed portion 423, followed by securing with adhesive.

To the open end 424 of each mount 420, i.e., the end closer to the circuit unit 440, one end portion of the corresponding base 460 is inserted and fixed to the base 460 with the use of adhesive, screws, or an engaging mechanism. In addition, on the main surface 425 facing toward the circuit unit 440, a corresponding one of the LED modules 410 is disposed in a position to have the main emission direction parallel to the lamp axis Z.

### (3) Outer Tube

The outer tube 430 has the shape of a hollow tube having two open ends. The outer tube 430 is not particularly limited to a specific shape (type). In the present embodiment, the outer tube 430 is a straight outer tube that models after a straight-type HID lamp. According to the present embodiment, the outer tube 430 is colorless transparent. Therefore, light incident on the inner surface 432 of the outer tube 430 passes through the outer tube 430 without being diffused. In the present embodiment, the lamp axis Z is in alignment with the tube axis (not illustrated) of the outer tube 430. Note that the outer tube 430 is not necessarily colorless transparent and may be colored transparent. In addition, the inner surface 432 of the outer tube 430 may be processed with silica, white pigment, or the like to impart the property of diffusing light emitted from the LED module 410.

### (4) Circuit Unit

The circuit unit 440 includes a circular circuit board 441 and various electronic components 442 and 443 mounted on the circuit board 441. Note that the electronic components 442 and 443 are mounted on a different one of the main surfaces 444 and 445 of the circuit board 441. Although the figure only shows some of electronic components with reference signs, there are other electronic components to which no reference signs have been applied.

The circuit unit 440 is located inside the outer tube 430, and more specifically in the axially central section of the outer tube 430. The axially central section is as defined in the first embodiment according to the first invention.

The circuit unit 440 is supported on the respective main surfaces 444 and 445 by the two supports 470. More specifically, a tip portion of one of the supports 470 is bonded to the main surface 444, whereas a tip portion of the other one of the supports is bonded to the main surface 445. That is, the circuit unit 440 is supported by the two supports 470 from both sides along the lamp axis Z. Note, in addition, that the number of supports 470 supporting the circuit unit 440 is not limited to two, and only one support or three or more supports may be used. Furthermore, the method for fixing the circuit unit 440 to the supports 470 is not limited to the bonding described above, and screws or an engaging mechanic may alternatively be used.

### (5) Light Diffusers

Each light diffuser 450 is a block-shaped member and at least a region of the outer surfaces 451 is a reflective region. The light diffusers 450 are disposed along the lamp axis Z, and the circuit unit 440 is disposed therebetween. According to the present embodiment, the outer shape of each light diffuser 450 is a regular icosahedron and the entire outer surfaces 451 are reflective surfaces. Note that the outer shape of the light diffusers 450 is not limited to a regular icosahedron as long as the outer surfaces 451 of the light diffusers 450 reflect and scatter light. Most of light emitted from each LED module 10 reaches the outer surfaces 451 of a closer one of the light diffusers 450 and is reflected off the outer surfaces 451 to be scattered in various directions.

Each light diffuser 450 is disposed in the axially central section of the outer tube 430 and in a state being supported by one of the supports 470. Preferably, the center O of each light diffuser 450 is located within the axially central section of the outer tube 430, and more preferably each light diffuser 450 is located entirely within the axially central section of the outer tube 430. Note, in addition, that the number of supports 470 supporting each light diffuser 450 is not limited to one, and two or more supports may be used. In addition, the light diffusers 450 may be supported by one or more supports that are different from the supports 470 supporting the circuit unit 440.

An appropriate one or more of the outer surfaces 451 of each light diffuser 450 have an engaging groove 452 extending along the lamp axis Z. The engaging groove 452 is for receiving a corresponding one of the supports 470. Each light diffuser 450 is supported by a different one of the supports 470, by fitting part of the support 470 into the engaging groove 452 of the light diffuser 450, followed by securing with adhesive. Note that the method for fixing the circuit unit 450 to the supports 470 is not limited to the bonding described above, and screws or an engaging mechanic may be used.

### (6) Base

The base 460 is for receiving power supply from the socket of a lighting fixture when the light source device 400 is attached to the lighting fixture and driven. The base 460 is not limited to any specific type. In this embodiment, an FC2 base, which is a pin base, is used. The base 460 is constructed from a terminal plate 461 and a metal terminal rod 462 attached to the terminal plate 461. A connection terminal 463 is disposed on the circuit unit 440 at a position facing toward the terminal plate 461. The connection terminal 463 is for electrical connection with an input terminal for the circuit unit 440.

### (7) Supports

Each of the supports 470 is a straight pipe made, for example, of glass, metal, or resin. Each support is bonded to the closure plate 422 with one end bonded to the circuit unit 440 and another end inserted in a through hole 426 in a closure plate 422 of the mount 420. The supports 470 are disposed to extend along one imaginary axis that is parallel to the lamp axis Z.

For each LED module 410, a pair of wiring lines 444 and 445 is provided for electrically connecting the output terminal of the circuit unit 440 and the input terminal of the LED module 410. That is, there are as many pairs of wiring lines as the number of LED modules 410, which in this embodiment is two. The wiring lines 444 and 445 in each pair pass through the interior passage of a corresponding one of the supports 470 to reach a location closer a corresponding one of the mounts 420. The wiring lines 444 and 445 in each pair are then turned back to pass through a through hole 427 formed in a corresponding one of the closure plates 422 and connected to the LED module 410.

A pair of wiring lines 446 and 447 is provided for eclectically connecting the input terminal of the circuit unit 440 with a corresponding one of the bases 460. Each of the wiring lines 446 and 447 passes through the interior passage of a corresponding one of the supports 470 to reach a location closer toward a corresponding one of the mounts 420 and is connected to the connection terminal 463 of the base 460 attached to the mount 420.

It is applicable to employ thick wires as the wiring lines 444-447 in order to omit the supports 470, by using the wiring lines 444-447 to support the circuit unit 440 as well as the light diffuser 450.

[Path of Light Emitted from LEDs]

In the present embodiment, light emitted from the respective LED modules 410 toward the circuit unit 440 is reflected by the outer surfaces 451 of the nearest one of the light diffusers 450, so that the reflected light is emitted radially from the light diffuser 450 as if the light originated from the light diffuser 450. Therefore, the light distribution similar to that of an HID lamp is obtained. Especially notable is that light emitted from the respective LED modules 410 travel toward each of the two light diffusers 450 from mutually opposite directions along the lamp axis Z, so that the light diffusers 450 emit light sufficiently and evenly in both directions along the lamp axis Z.

### [Heat Dissipation Path]

According to the present embodiment, the circuit unit 440 is not located between the base 460 and either of the LED modules 410. Therefore, similarly to the light source device 1 according to the first embodiment of the first invention, heat load to be imposed on the circuit unit 440 is kept small. This construction permits a greater number of LEDs 412 to be included or a higher electric current to be input. In addition, it is not necessary to provide heat dissipating means, such as a heat sink, which is advantageous for avoiding upsizing of the light source device 400. In addition, the mount 420 of a smaller size may be usable.

### Sixth Embodiment of First Invention

A light source device according to a sixth embodiment of the first invention differs from the light source device 400 according to the fifth embodiment of the first invention in that only one light diffuser is included and that the circuit unit is contained in the light diffuser. Other than that, the construction of the light source device according to this embodiment is basically the same as that of the light source device 400 according to the fifth embodiment of the first invention. The following description is therefore given only of the difference and a description of other components is omitted. Note that the same components as those of the fifth embodiment of the first invention are designated by the same reference signs as those used in the first embodiment of the first invention.

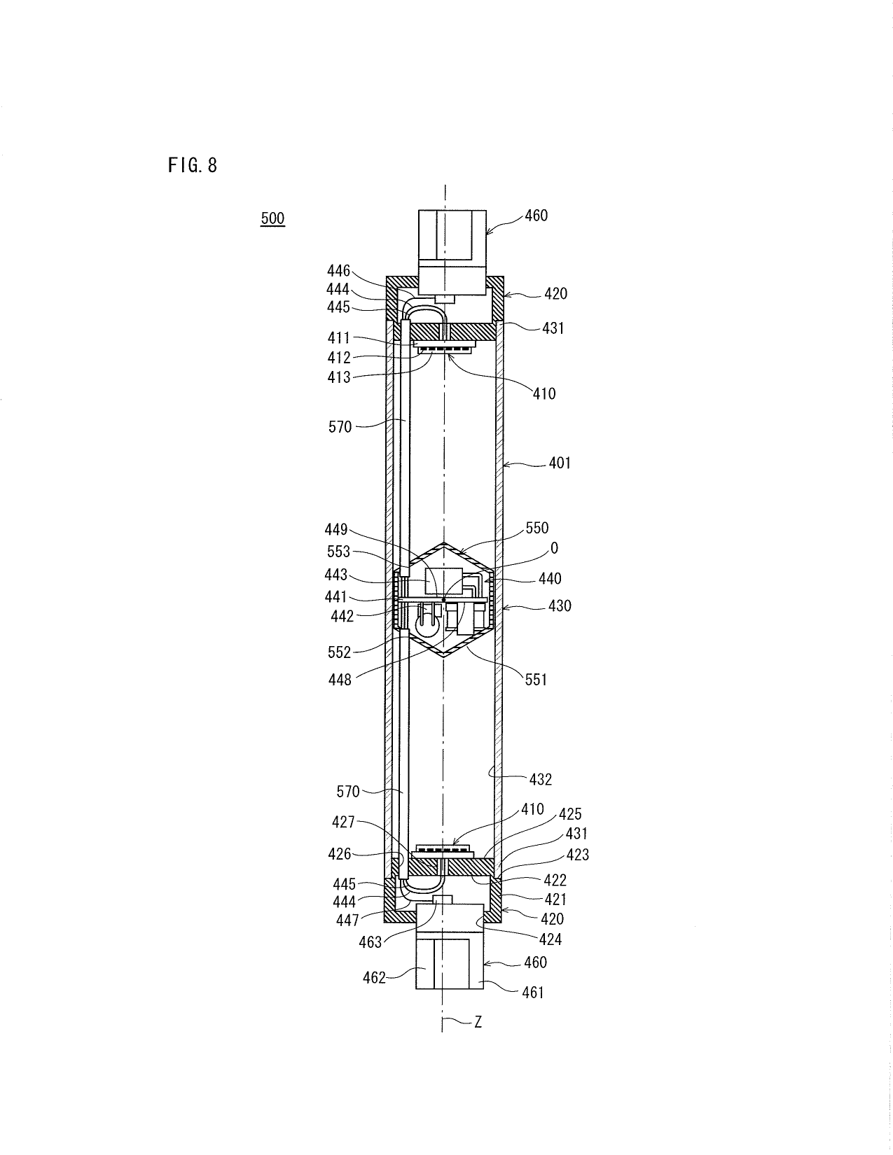

FIG. 8 is a sectional view of a light source device according to the sixth embodiment of the first invention. As shown in FIG. 8, the light source device 500 according to the sixth embodiment of the first invention includes a pair of LED modules 410, a pair of mounts 420, an outer tube 430, a circuit unit 440, a light diffuser 550, a pair of bases 460, and a pair of supports 470.

The light diffuser 550 has substantially the same outer shape as that of the light diffuser 450 according to the fifth embodiment of the first invention. Note, however, that although the light diffuser 450 according to the fifth embodiment of the first invention is solid, the light diffuser 550 is a hollow body and contains a circuit unit 440 in the hollow interior.

The entire outer surface 551 of the light diffuser 550 is a reflective region that reflects and diffuses light. Of the outer surface 551, part that faces toward one of the LED modules 410 receives light emitted from that LED module 410, whereas part that faces toward the other LED module 410 receives light emitted from the other LED module 410.

With the construction of the present embodiment, the reflective region of the light diffuser 550 is ensured to be closer to the center of the outer tube 430. Consequently, the light distribution similar to that of an HID lamp is obtained. In addition, since the circuit unit 440 is entirely concealed inside the light diffuser 550, the appearance of the light source device 1 improves, and this improvement is especially notable when the outer tube 430 is colorless transparent. Also, since almost none of light emitted by the LED modules 410 is absorbed by the circuit unit 440, the intensity of the light source device 1 can be further improved.

### <Modifications>

Up to this point, the light source devices according to the present invention have been specifically described by way of the first to sixth embodiments of the first invention. However, the light source devices according to the present invention are not limited to those according to the first to sixth embodiments of the present invention. For example, a light source device constructed by combining parts of the light source devices according to the first to sixth embodiments of the first invention may still fall within the scope of the present invention. In addition, the specific materials, values, and the like mentioned above are merely preferable examples and not to be construed as limiting. Various modifications may be made as appropriate, without departing from the technical concepts of the present invention.

The descriptions of the first to sixth embodiments of the first invention are all directed to cases where LEDs are used as semiconductor light-emitting elements. Alternatively, however, the semiconductor light-emitting elements may be LDs (laser diodes) or electroluminescence (EL) elements.

Still further, the following modifications are possible.

### [LED Module]

### (1) Mounting Board

The mounting board may be an existing mounting board, such as a resin board, a ceramics board, a metal-based board which is made of a resin board and a metal board, or the like.

### (2) LEDs

Although LEDs that emit blue light are employed in the above-described embodiments, it is applicable to use LEDs that emit another color of light. In addition, although only one type of LEDs is employed in the above-described embodiments, it is applicable to use different types of LEDs that emit different colors of light.

### (3) Sealant

According to the above embodiment, all the LEDs mounted on the mounting board are encapsulated in one sealant. Alternatively, however, the individual LEDs may be encapsulated in separate sealants or subsets of LEDs may be encapsulated in separate sealants.

Although the sealants according to the above-described embodiments are made from a transparent material not containing a wavelength converting material, it is applicable to form sealants form a transparent material containing a wavelength converting material mixed therein. It is also applicable to form sealants from a transparent material not containing a wavelength converting material and coat the surfaces of the sealants with a wavelength converting layer containing a wavelength converting material. It is also applicable to dispose a wavelength converter, such as a phosphor plate containing phosphor particles, outside the LED module to carry out wavelength conversion of emission light of the LED module.

### [Outer Tube]

Although the outer tube employed in the above-described embodiments is of a straight type, a different type of outer tube may be used. One example is an outer tube having a bulged portion in the axially central section. Alternatively, an outer tube having a shape that is totally different from an outer tube of an HID lamp may be used.

### [Circuit Unit]

According to the above-described embodiments, the circuit unit has one circuit board on which electronic components are mounted, so that the entire circuit unit is disposed on the side of the light diffuser opposite the semiconductor light-emitting element. Alternatively, however, it is applicable to place at least one or more components of the circuit unit on the side of the light diffuser at which the LED module is located. For example, the circuit unit may have two circuit boards and electronic components are mounted on the respective circuit boards. One of the circuit boards as well as the electronic components mounted on that circuit board is disposed on the side of the light diffuser opposite the LED module, whereas the other of the circuit board as well as the electronic components mounted on that circuit board is disposed on the side of the light diffuser at which the LED module is located.

In addition, it is not necessary that all of the electronic components constituting the circuit unit are disposed inside the outer tube. For example, the electronic components disposed on the side of the light diffuser at which the LED module is located may be disposed between the LED module and the base. In this case, it is preferable to dispose highly heat-resistant electronic components between the LED module and the base. This construction allows the interior space of the light diffuser to be reduced by the volume corresponding to the electronic components disposed outside the outer tube. In this manner, downsizing of the light diffuser is possible and therefore the light distribution even more similar to that of an HID lamp is obtained.

In the above-described embodiments, the circuit board of the circuit unit is disposed so that its main surface is perpendicular to lamp axis Z. Alternatively, the circuit board may be disposed to have its main surface parallel to the lamp axis Z or inclined with respect to the lamp axis Z.

### [Power Connector]

According to the above-described embodiments, an Edison base or a pin base is used. Alternatively, however, another type of base may be used or a power connector other than the base may be used. In addition, each base and mount used in the above-described embodiments is a hollow body. In one alternative example, it is applicable to fill the hollow interior with an insulating material having a higher conductivity than air. In this example, the material serves to conduct heat of the LED module more effectively to the base, so that the heat dissipation of the light source device is improved. Non-limiting examples of the above-mentioned material include a silicone resin.

### [Supplemental]

The above-described embodiments may be modified to additionally have a heat pipe between the circuit unit and the power connector in order to conduct heat of the circuit unit to the power connector. For example, a columnar heat pipe made of a highly thermal conductive material may be disposed between the circuit unit and the power connector with one end thermally coupled to the circuit unit and the other end thermally coupled to the power connector. In that case, it is preferable to reliably insulate the circuit unit from the power connector to prevent the passage of current via the heat pipe. An alternative to the provision of a heat pipe is to dispose the circuit board of the circuit unit in contact with the outer tube, thereby allowing heat of the circuit unit to be conducted to the power connector via the outer tube.

### Second Invention

The following now describes light source devices according to embodiments of the second invention, with reference to the drawings. The same components as those of the first invention are designated by the same reference signs as those used in the description of the first invention.

### First Embodiment of Second Invention

### [Schematic Construction]

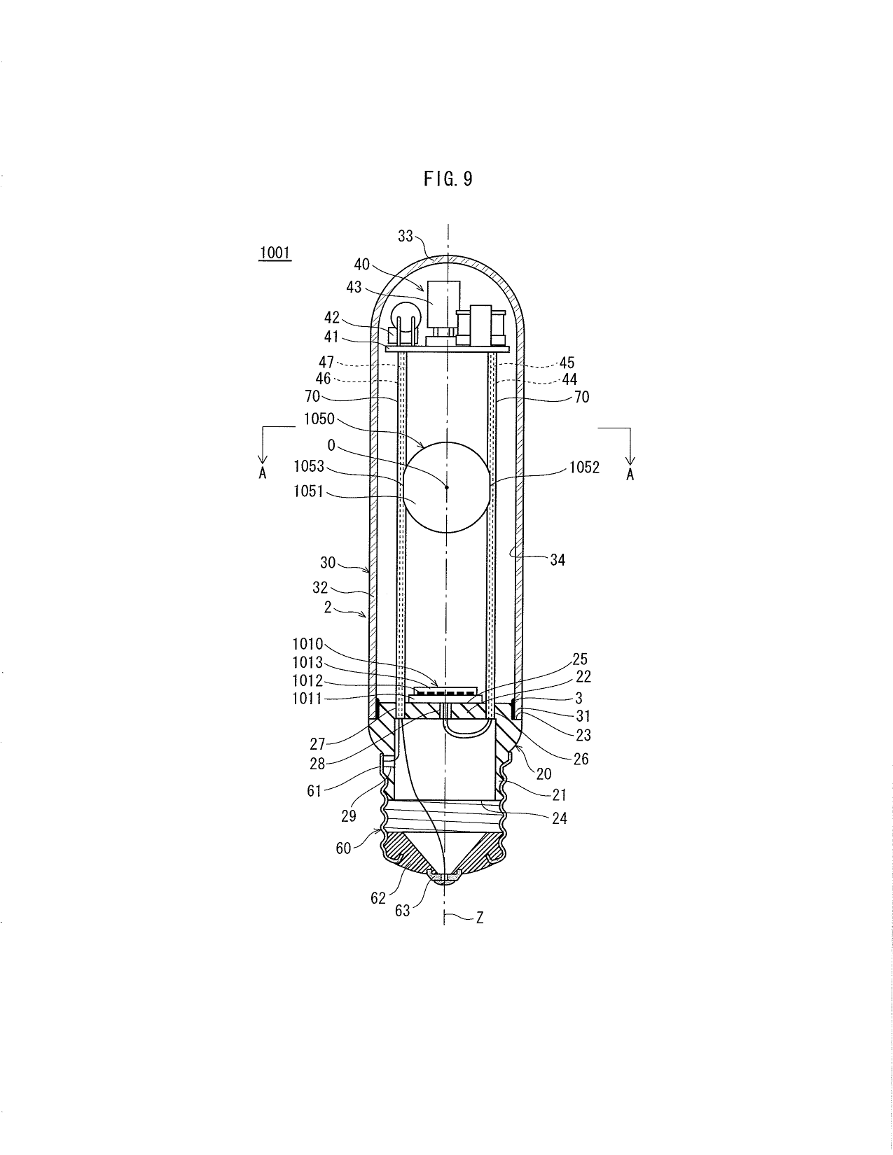

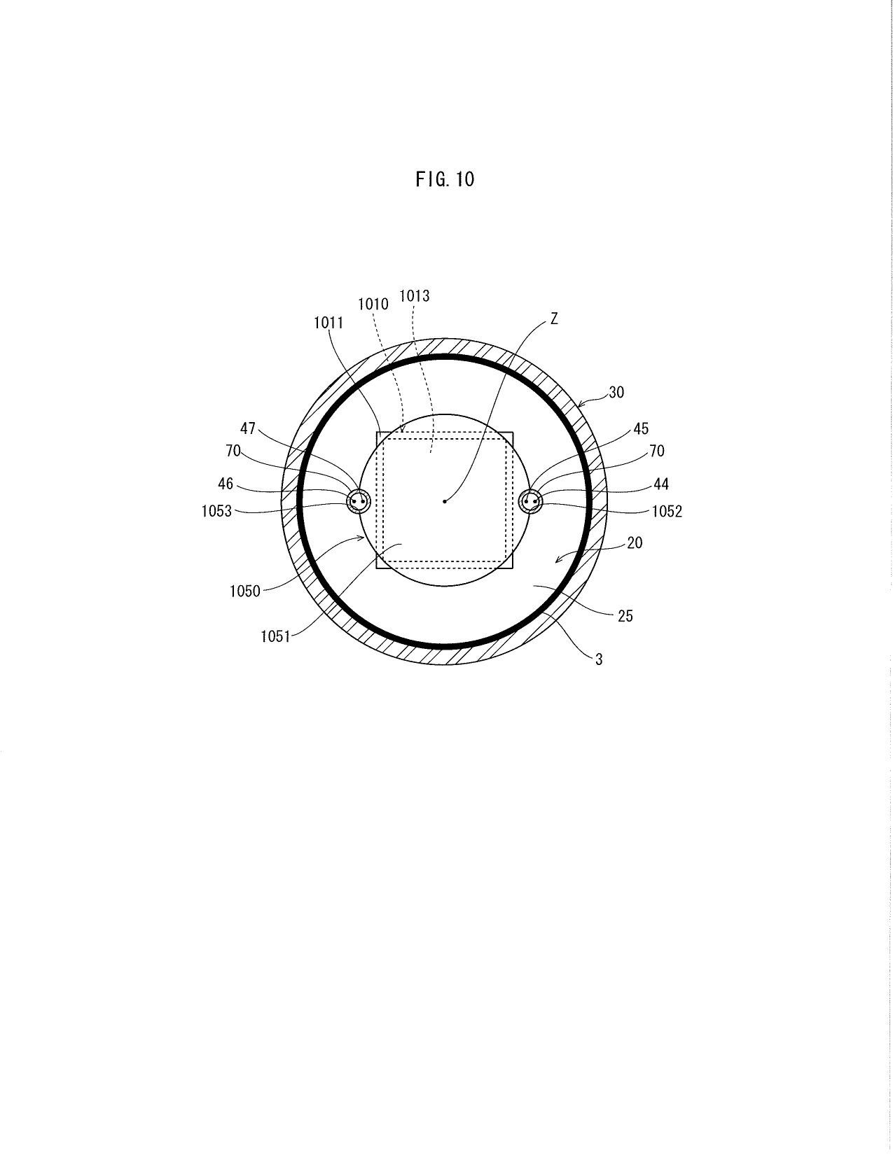

FIG. 9 is a sectional view of a light source device according to a first embodiment of the second invention, and FIG. 10 is a sectional view taken along the arrowed line A-A of FIG. 9.

As shown in FIG. 9, the light source device 1001 according to the first embodiment of the second invention is an LED lamp usable as a replacement for an HID lamp and includes an LED module 1010 as a light source, a mount 20 on which the LED module 1010 is mounted, an outer tube 30 housing the LED module 1010, a circuit unit 40 for driving the LED module 1010, a light diffuser 1050 for diffusing light emitted from the LED module 1010, and a base 60 that is electrically connected to the circuit unit 40.

In other words, the construction of the light source device 1001 is such that the LED module 1010 and the circuit unit 40 are housed in an envelope 2 that is formed from the mount 20, the outer tube 30, and the base 60. Disposed in the axially central section inside the outer tube 30 is a light diffuser 1050, which is a block of a material containing a wavelength converting material 1054. The light diffuser 1050 converts incident light into different wavelengths and radially emits the converted light. The LED module 1010 is disposed on the side of the light diffuser 1050 at which the base 60 is located and in an orientation to have its main emission direction pointing toward the light diffuser 1050. The circuit unit 40 is disposed on the side of the light diffuser 1050 opposite the LED module 1010. The circuit unit 40 and the light diffuser 1050 are supported by a pair of supports 70.

### [Construction of Components]

### (1) LED Module

The LED module 1010 includes a mounting board 1011, a plurality of semiconductor light-emitting elements 1012 (hereinafter, “LEDs 1012”) acting as a light source and mounted on a main surface of the mounting board 1011, and a sealant 1013 mounted on the mounting board 1011 in a manner to encapsulate the LEDs 1012. The sealant 1013 is mainly composed of a transparent material. In the case where emission light of the LEDs 1012 needs to be converted into predetermined wavelengths, a wavelength converting material is mixed into the transparent material. Examples of the transparent material include a silicone resin, and examples of the wavelength converting material include phosphor particles.

In the present embodiment, the LEDs 1012 are ones that emit blue light, and the sealant 1013 is made of a colorless transparent material not containing a wavelength converting material. Thus, light emitted from the LEDs 1012 emerges from the LED module 1010 as blue light, without wavelength conversion by the sealant 1013.

The LED module 1010 is mounted on the mount 20 inside the outer tube 30 in the substantially same manner as the LED module 10 according to the first invention and electrically connected to the circuit unit 40.

### (2) Light Diffuser

The light diffuser 1050 is a sphere (a solid body having a spherical outer shape) made of a transparent material containing a wavelength converting material mixed therein. The light diffuser 1050 converts part of incident blue light to yellow light and emits the converted yellow light together with the unconverted blue light from the entire outer surface 1051. As a result of mixture of blue light and yellow light both emitted from the light diffuser 1050, the light diffuser 1050 appears to radiate white light from the entire outer surface 1051.

Note that the shape of the light diffuser 1050 is not limited to a sphere and any other shape is applicable as long as its outer surface(s) can cause radial light emission. For example, the outer shape of the light diffuser 1050 is not limited to a sphere and may be a regular polyhedron, such as a regular tetrahedron, a regular hexahedron, a regular octahedron, a regular dodecahedron, or any other polyhedron. In addition, the light diffuser 1050 is not limited to be solid and may alternatively be hollow in order to reduce the weight or to house components inside. In that case, the inner surface of the light diffuser 1050 may be made reflective to prevent loss of light as a result that light enters into the hollow interior.

In order for the light diffuser 1050 to reflect light uniformly in all directions, the desirable outer shape of the light diffuser 1050 is one of a regular polyhedron, a semi-regular polyhedron, a quasi-regular polyhedron, or a sphere. Among those shapes, a sphere is particularly preferable. Note that the light diffuser 1050 is not limited to the one that emits light from the entire outer surface 1051. Alternatively, the light diffuser 1050 may have a region that does not contribute to light emission, provided that such a region does not interfere with radial emission of light.

Examples of the transparent material usable for the light diffuser 1050 include a resin material such as polycarbonate. In addition, examples of the wavelength converting material mixed into the transparent material include phosphor particles. In the present embodiment, a phosphor that converts blue light into yellow light is used. Note that the material for the light diffuser 1050 is not limited to a resin and may alternatively be glass.

The light diffuser 1050 is disposed in the outer tube 30 at a position between the LED module 1010 and the circuit unit 40, and the main emission direction is directed toward the light diffuser 1050. Most of light emitted from the LED module 1010 reaches the outer surface 1051 of the light diffuser 1050 where the incident light undergoes wavelength conversion and then the resulting light is emitted radially from the outer surface 1051.

As shown in FIG. 10, the sealant 1013 of the LED module 1010 is located directly below the light diffuser 1050 in plan view of the light source device 1001 (i.e., when the light source device 1001 is seen from the direction opposite the base 60 along the lamp axis Z, i.e., when the light source device 1001 is seen from the top to the bottom in FIG. 10). Therefore, the sealant 1013 is completely hidden below the light diffuser 1050 in plan view of the light source device 1001. This arrangement ensures that light emitted from the LED module 1010 in the main emission direction (in the directly upward direction in FIG. 10) efficiency reaches the outer surface 1051 of the light diffuser 1050. In addition, none of light emitted from the LED module 1010 in the main emission direction reaches the circuit unit 40 as it is blocked by the light diffuser 1050, so that absorption of light by the circuit unit 40 is prevented.

FIG. 3 is an explanatory diagram of the center of the outer tube and the axially central section of the outer tube. The light diffuser 1050 is disposed so that the center O of the light diffuser 1050 (the center of the regular icosahedron in the present embodiment, see FIG. 9) coincides with the center M of the outer tube 30 (see FIG. 3) in the axially central section of the outer tube 30. The center O of the light diffuser 1050 is also the optical center of the light source device 1001. In the present embodiment, the lamp axis Z is in alignment with the tube axis J of the outer tube 30.

The center M of the outer tube 30 is defined to be a midpoint between Points P and Q, where P denotes an intersection point of a plane containing the open end 35 of the outer tube 30 with the tube axis J, and Q denotes an intersection point of the outer surface 36 of the top portion 33 of the outer tube 30 with the tube axis J. In addition, the axially central section of the outer tube 30 refers to a section between Points R and S (crosshatched area in FIG. 3), where L denotes the length of the outer tube 30 (equal to the distance between Points P and Q), and each of Points R and S is away from the center M along the tube axis J toward Points P and Q, respectively, by the distance equal to 25% of the distance L (i.e., L/4).

Note that the center O of the light diffuser 1050 is not required to coincide with the center M of the outer tube 30. Yet, in view of the light distribution, the positional relation should preferably satisfy the condition that at least the center O of the light diffuser 1050 is located within the axially central section of the outer tube 30, and more preferably satisfy the condition that the light diffuser 1050 is located entirely within the axially central section of the outer tube 30.

Referring back to FIG. 10, the light diffuser 1050 is held in place between the pair of supports 70 by being supported by the supports 70. The light diffuser 1050 has two engaging grooves 1052 and 1053 formed in the outer surface 1051. The engaging grooves 1052 and 1053 are for engagement with the supports 70 and extend in a direction along the lamp axis Z. In the state where the supports 70 are received within the engaging grooves 1052 and 1053, adhesive is poured into the grooves 1052 and 1053. As a result, the light diffuser 1050 is secured to the pair of supports 70. As described above, the light diffuser 1050 is secured at two locations using both the engaging structure and adhesive. Therefore, the risk of accidental detachment of the light diffuser 1050 from the pair of supports 70 is little. Note that the method to fix the light diffuser 1050 to the pair of supports 70 is not limited to that described above. Alternatively, the light diffuser 1050 may be fixed to the pair of supports with screws, for example.

The light diffuser 1050 is supported by the supports 70 in the substantially same manner as the light diffuser 50 according to the first invention. Alternatively to the supports 70, the wiring lines 44-47 of a larger diameter may be used to support the light diffuser 1050. In that case, the light diffuser 1050 is secured to the wiring lines 44-47. In the manner described above, the wiring lines 44-47 may be used as supports.

### [Light Diffusion by Light Diffuser]

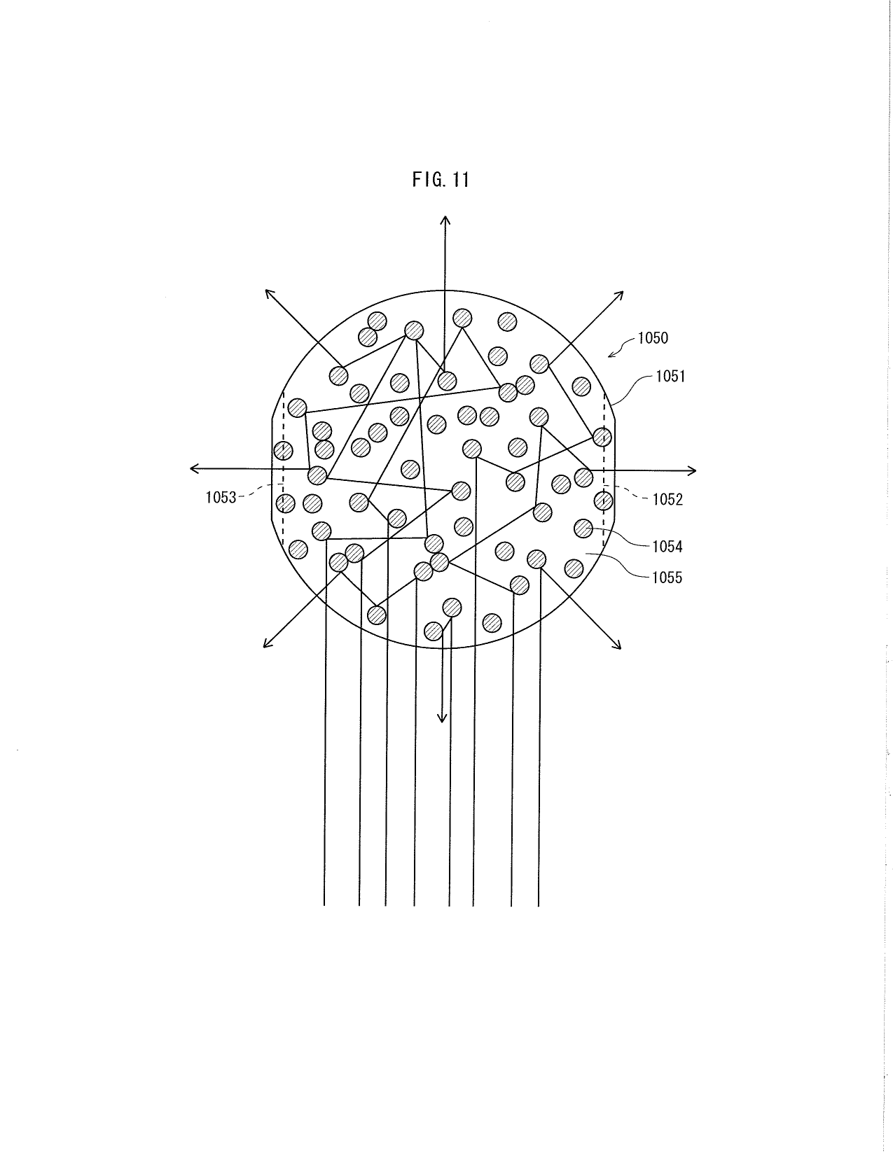

FIG. 11 is a schematic illustration of light diffusion by the light diffuser. As shown in FIG. 11, the light diffuser 1050 according to the present embodiment is made of a transparent material 1055 containing a wavelength converting material 1054 mixed therein.

Blue light emitted from the LED module 1010 (from the bottom in FIG. 11) toward the light diffuser 1050 reaches the outer surface 1051 and then enters the light diffuser 1050. In the light diffuser 1050, light is repeatedly reflected by particles of the wavelength converting material 1054 contained in the light diffuser 1050. As a result, light is radially emitted in all directions uniformly from the entire outer surface 1051.

In addition, part of the blue light entered the light diffuser 1050 is converted into yellow light by the wavelength converting material 1054. Since the particles of the wavelength converting material 1054 radially emit yellow light resulting from the wavelength conversion in all directions, yellow light emerges radially from the entire outer surface 1051 of the light diffuser 1050 into all directions uniformly.

As a result of mixture of blue light and yellow light both emitted from the light diffuser 1050, white light is produced. The resulting white light travels radially from the light diffuser 1050 as if the white light were emitted from the light diffuser 1050. Therefore, the light distribution similar to that of an HID lamp is obtained. The emitted light then exits to the outside after passing through the outer tube 30.

Since the light diffuser 1050 conducts wavelength conversion, the light source device 1001 may be modified to emit light in a color different from emission color of the LED module 1010. Therefore, by adjusting the type and amount of phosphor particles contained in the light diffuser 1050, the emission color of the light source device 1001 is suitably adjusted. That is, with the use of the LED module 1010 of a specific emission color, various types of the light source device 1001 having different emission colors can be manufactured simply by changing the composition of phosphor particles contained in the light diffuser 1050.

### [Heat Dissipation Path]

According to the present embodiment, the circuit unit 40 is disposed on the side of the light diffuser 1050 opposite the LED module 1010. This construction permits a greater number of LEDs 1012 to be employed or a higher electric current to be input. When a greater number of LEDs 1012 is employed or a higher electric current is input to the LEDs 1012, the amount of heat generated by the LED module 1010 increases. Yet, since the circuit unit 40 is not located between the LED module 1010 and the base 60, the distance between the LED module 1010 and the base 60 is relatively short, which leads to more effective heat transfer from the LED module 1010 to the base 60.

### Second Embodiment of Second Invention

A light source device according to a second embodiment of the second invention differs from the light source device 1001 according to the first embodiment of the second invention in that a lens is provided between the LED module and the light diffuser in order to gather emission light of the LED module to the light diffuser. Other than that, the construction of the light source device according to this embodiment is basically the same as that of the light source device 1001 according to the first embodiment of the second invention. The following description is therefore given only of the difference, and a description of other components is omitted. Note that the same components as those of the first embodiment of the second invention are designated by the same reference signs as those used in the first embodiment of the second invention.

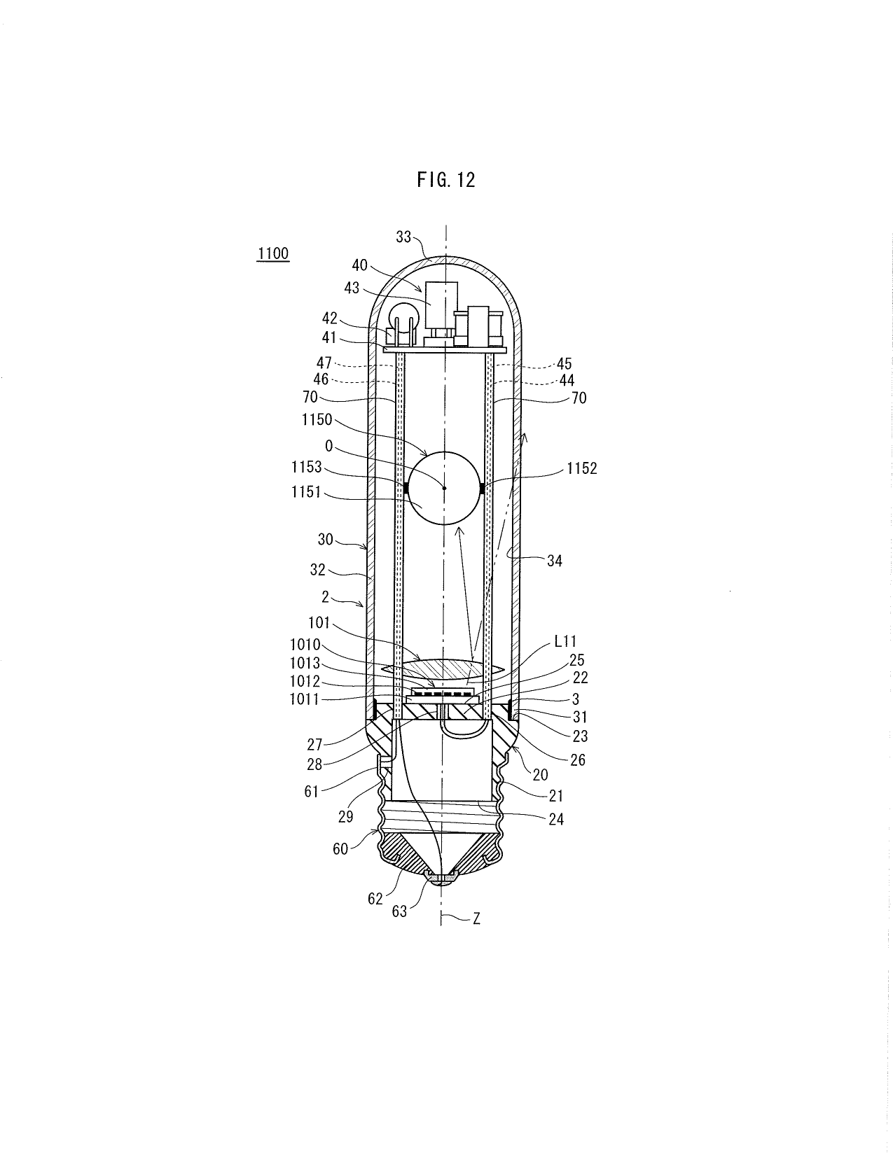

FIG. 12 is a sectional view of a light source device according to the second embodiment of the second invention. As shown in FIG. 12, a light source device 1100 according to the second embodiment of the second invention includes an LED module 1010, a mount 20, an outer tube 30, a circuit unit 40, a light diffuser 1150, a base 60 and a pair of supports 70. In addition, a lens 101 is provided between the LED module 1010 and the light diffuser 1150.

The lens 101 is for gathering emission light of the LED module 1010 to the outer surface 1151 of the light diffuser 1150. In the present embodiment, a biconvex lens is used. By the action of the lens 101, the light emitted from the LED module 1010 is gathered to the outer surface 1151 of the light diffuser 1150. Note that the lens 101 is not limited to a biconvex lens and may alternatively be a plano-convex lens. Furthermore, the lens 101 is not limited to a lens that collimates light from the LED module 1010 into parallel light that travels along the amp axis Z. Any lens is usable as long as it collects light onto the outer surface 1151 of the light diffuser 1150.

Note that the light diffuser 1150 is one size smaller (in outer diameter) than the light diffuser 1050 used in the first embodiment of the second invention, and therefore the total area of the outer surface 1151 is smaller than that of the outer surface 1051. This construction permits emission of light originated from a narrower area, which is advantageous to achieve the light distribution even more similar to that of as the HID lamp. Different from the light diffuser 1050 according to the first embodiment of the second invention, the light diffuser 1150 is not provided with the engaging grooves 1052 and 1053. Instead, the light diffuser 1150 is fixed to the pair of supports 70 with adhesive 1152 and 1153 at two locations on the outer surface 1151.

According to the construction of the above embodiment, a ray of light L11 that is emitted at an angle not toward the outer surface 1151 of the light diffuser 1150 as indicated by the chain double-dashed line changes the direction of travel by passing through the lens 101 and falls on the outer surface 1151 of the light diffuser 1150. Therefore, more light is gathered onto the light diffuser 1150, so that more light is converted into different wavelengths and then scattered by the light diffuser 1150. In addition, since the amount of light traveling toward the base 60 increases, light is efficiency collected, for example, to a reflecting mirror (not illustrated) of a lighting fixture.

### Second Embodiment of Third Invention

A light source device according to a third embodiment of the second invention differs from the light source device 1001 according to the first embodiment of the second invention in that a concave reflecting mirror is disposed between the LED module and the base. The concave reflecting mirror has a concave reflective surface facing toward the light diffuser, so that light emitted from the LED module is gathered to the light diffuser. Other than that, the construction of the light source device according to this embodiment is basically the same as that of the light source device 1 according to the first embodiment of the second invention. The following description is therefore given only of the difference, and a description of other components is omitted. Note that the same components as those of the first embodiment of the second invention are designated by the same reference signs as those used in the first embodiment of the second invention.

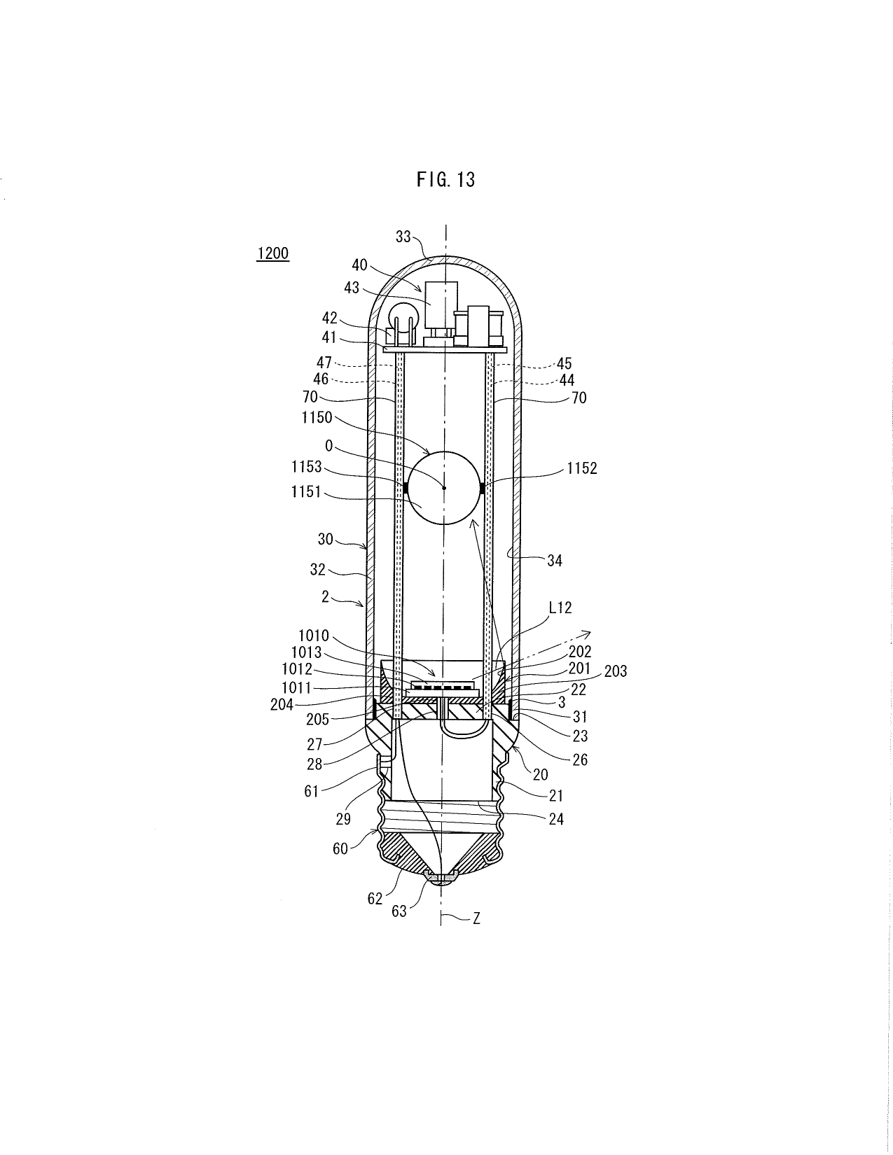

FIG. 13 is a sectional view of a light source device according to the third embodiment of the second invention. As shown in FIG. 13, a light source device 1200 according to the third embodiment of the second invention includes an LED module 1010, a mount 20, an outer tube 30, a circuit unit 40, a light diffuser 1150, a base 60 and a pair of supports 70. In addition, a concave reflecting mirror 201 is provided between the LED module 1010 and the base 60.

The concave reflecting mirror 201 has a concave reflective surface 202 and is disposed on the main surface 25, of the closure plate 22 of the mount 202, facing toward the circuit unit 40, in such an orientation to have the reflective surface 202 facing toward the light diffuser 1150. The LED module 1010 is disposed centrally on the reflective surface 202. Light emitted from the LED module 1010 and incident on the reflective surface 202 is collected to the outer surface 1151 of the light diffuser 1150.

The concave reflecting mirror 201 has through holes 203 and 204 at positions corresponding to the through holes 26 and 27 in the mount 20, for allowing the supports 70 to pass through. In addition, the concave reflecting mirror 201 also has a through hole 205 at a position corresponding to the through hole 28 in the mount 20, for allowing wiring lines 44 and 45 to pass through.

With the construction of the present embodiment, a ray of light L12 emitted in a lateral direction indicated by the chain double-dashed line (i.e., in the direction perpendicular to or nearly perpendicular to the main emission direction) is changed the direction of travel by the reflective surface 202 of the concave reflecting mirror 201 and falls on the outer surface 1151 of the light diffuser 1150. Therefore, more light is gathered onto the light diffuser 1150 and more light is scattered by the outer surface 1151 of the light diffuser 1150. In addition, light that would otherwise exit the outer tube 30 from the open end portion 31 as indicated by the chain double-dashed line is collected to the light diffuser 1150 and is ultimately released from the axially central section of the outer tube 30.

### Fourth Embodiment of Second Invention

A light source device according to a fourth embodiment of the second invention differs from the light source device 1001 according to the first embodiment of the second invention in that a concave reflecting mirror is disposed between the light diffuser and the circuit unit. The concave reflecting mirror has a concave reflective surface facing toward the light diffuser, so that light emitted from the LED module is gathered to the light diffuser. Other than that, the construction of the light source device according to this embodiment is basically the same as that of the light source device 1001 according to the first embodiment of the second invention. The following description is therefore given only of the difference and a description of other components is omitted. Note that the same components as those of the first embodiment of the second invention are designated by the same reference signs as those used in the first embodiment of the second invention.

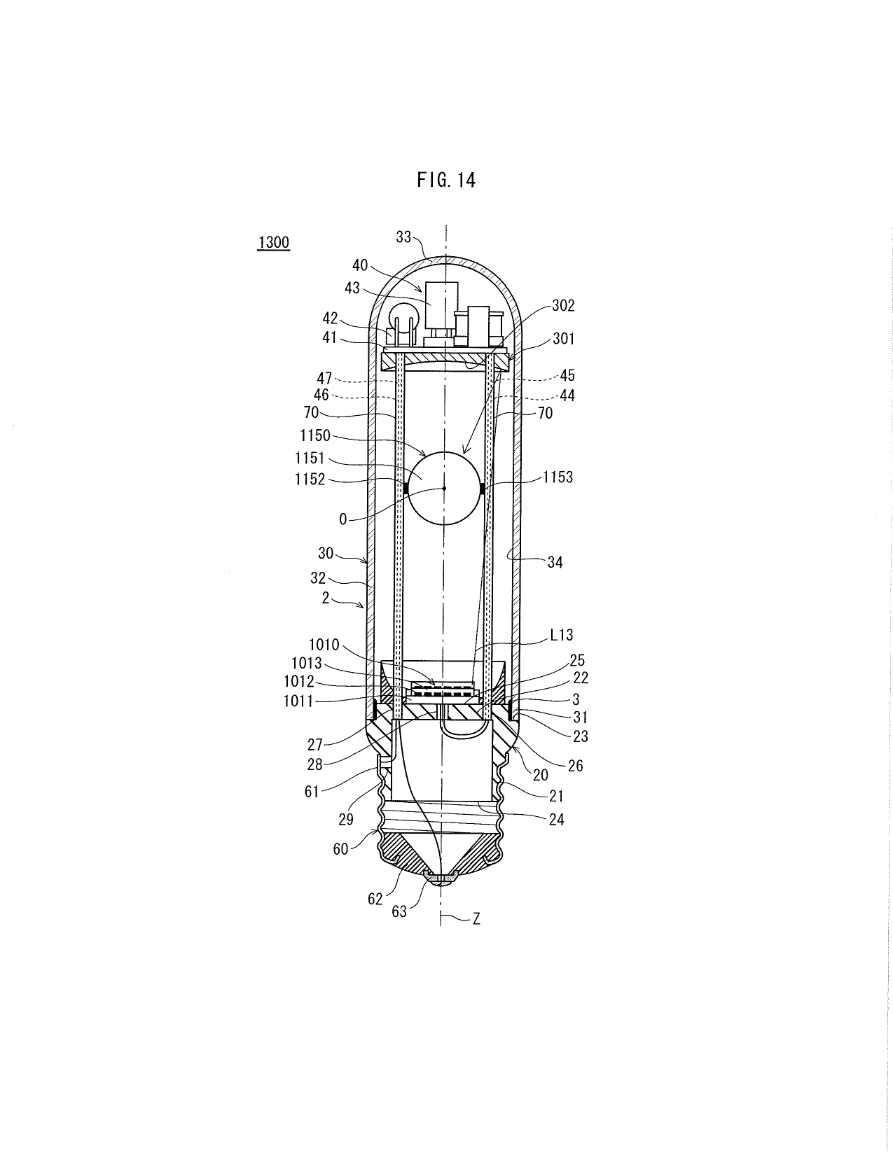

FIG. 14 is a sectional view of a light source device according to the fourth embodiment of the second invention. As shown in FIG. 14, a light source device 1300 according to the fourth embodiment of the second invention includes an LED module 1010, a mount 20, an outer tube 30, a circuit unit 40, a light diffuser 1150, a base 60 and a pair of supports 70. In addition, a concave reflecting mirror 301 is provided between the light diffuser 1150 and the circuit unit 40.

The concave reflecting mirror 301 has a concave reflective surface 302 and is fixed by adhesive to the main surface, of the circuit board 41 of the circuit unit 40, facing toward the base 60, in such an orientation to have the reflective surface 302 facing toward the light diffuser 1150. The concave reflecting mirror 301 has through holes 303 and 304 for allowing the supports 70 to pass through. Each support 70 passes through a corresponding one of the through holes 303 and 304 and is bonded to the circuit board 41 of the circuit unit 40.

When seen from the direction along the lamp axis Z, the reflective surface 302 is larger than the circuit board 41 of the circuit unit 40. Therefore, a ray of light L13 emitted from the LED module 1010 toward the circuit board 41 is reflected off the reflective surface 302 to fall on the outer surface 351 of the light diffuser 1150. The light diffuser 1150 is one size smaller than the light diffuser 1050 according to the first embodiment of the second invention for allowing part of light emitted from the LED module 1010 to reach the reflective surface 302 of the concave reflecting mirror 301 without hitting the outer surface 1151 of the light diffuser 1150.

According to the construction of the present embodiment, a ray of light L13 that is emitted from the LED module 1010 toward the reflective surface 302 of the concave reflecting mirror 301 travels without being reflected by the outer surface 351 of the light diffuser 1150 and is reflected by the reflective surface 302 to fall on part of the outer surface 351, of the light diffuser 1150, facing away from the LED module 1010. As a consequence, of the outer surface 351 of the light diffuser 1150, the part facing away from the LED module 1010 is caused to reflect more light, which achieves a radial diffusion of light from the light diffuser 1150. That is, a light distribution even more similar to that of an HID lamp is achieved.

### Fifth Embodiment of Second Invention

A light source device according to a fifth embodiment of the second invention significantly differs from the light source device 1001 according to the first embodiment of the second invention in that the light source device is of a bi-base type and that two light diffusers are disposed with a circuit unit located inbetween. The following description focuses on points greatly different from the light source device 1001 according to the first embodiment of the second invention, whereas a description of common points is omitted or given only briefly.

### [Schematic Construction]

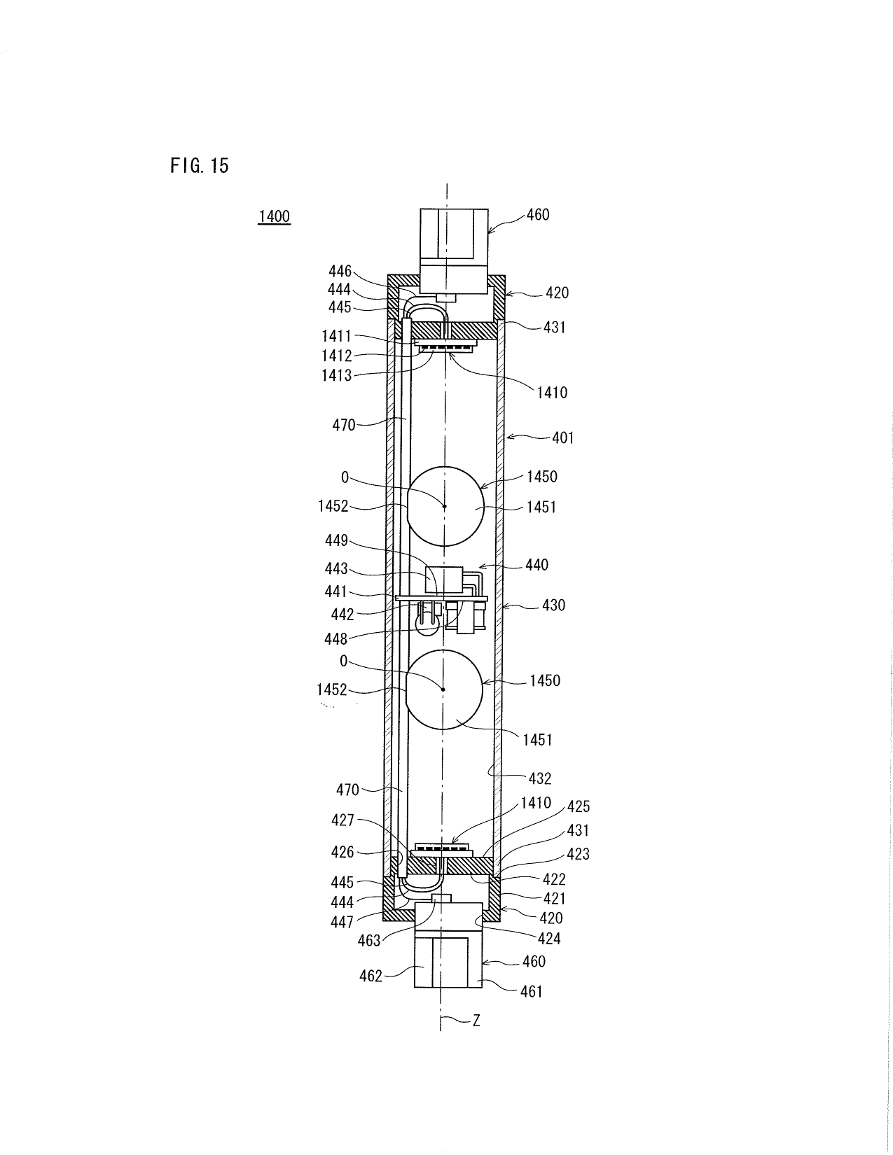

FIG. 15 is a sectional view of a light source device according to the fifth embodiment of the second invention. As shown in FIG. 15, the light source device 1400 according to the fifth embodiment of the second invention is an LED lamp usable as a replacement for a bi-base HID lamp and includes a pair of LED modules 1410 each serving as a light source, a pair of mounts 420 each having one of the LED modules 1410 mounted thereon, an outer tube 430 in which the mounts 420 are disposed one at each end of the outer tube 430, a circuit unit 440 for driving the LED modules 1410, a pair of light diffusers 1450 each disposed in an axially opposite relation with one of the LED modules 1410, and a pair of bases 460 serving as a pair of power connectors that are electrically connected to the circuit unit 440.

In other words, the construction of the light source device 1400 is such that the pair of LED modules 1410, each of which serves as a light source, and the circuit unit 440 for driving the LED modules 1410 are housed in an envelope 401. The envelope 401 is formed from the outer tube 430, which is a hollow tube having both ends open, and the pair of bases 460 disposed one at each end of the outer tube 430. In the axially central section of the outer tube 430, the two light diffusers 1450 are disposed along the tube axis direction. Each light diffuser 1450 is made of a material containing a wavelength converting material and thus converts incident light into different wavelengths and emits the resultant light radially. Each LED module 1410 is disposed at a position between one of the light diffusers 1450 and one of the bases 460 closer to the light diffuser 1450, in such an orientation to have the main emission direction pointing toward the light diffuser 1450. The circuit unit 440 is disposed between the two light diffusers 1450, and the circuit unit 440 as well as the light diffusers 1450 is supported by a pair of supports 470.

### [Construction of Components]

### (1) LED Modules

The construction of each LED module 1410 is substantially identical to the LED module 1010 according to the first embodiment of the second invention. That is, each LED module 1410 has a mounting board 1411 and a plurality of LEDs (a set of LEDs) 1412 mounted as a light source on a surface of the mounting board 1411, and a sealant 1413 disposed on the mounting board 1411 to encapsulate the LEDs 1412. Similarly to the first embodiment of the second invention, the present embodiment employs the LEDs 1412 that emit blue light and the sealants 1413 made of a transparent material not containing wavelength converting material. Thus, the LED modules 1410 emit blue light.

The LED module 1410 is mounted on the mount 420 inside the outer tube 430 in the substantially same manner as the LED module 410 according to the first invention and electrically connected to the circuit unit 440.

### (2) Light Diffusers

Each light diffuser 1450 is a sphere (a solid body having a spherical outer shape) made of a transparent material containing a wavelength converting material. The light diffusers 1450 convert part of incident blue light to yellow light and emits the converted yellow light together with the unconverted blue light from the entire outer surface 1451 of each light diffuser 1450. As a result of mixture of blue light and yellow light both emitted from the light diffusers 1450, each light diffuser 1450 appears to radiate white light from the entire outer surface 1451.

Each light diffuser 1450 is a sphere and at least a region of its outer surface 1451 is reflective. The light diffusers 1450 are disposed along the lamp axis Z so as to have the circuit unit 440 therebetween. Note that the shape of the light diffuser 1450 is not limited to a spherical as long as the shape allows light to be emitted radially from the outer surface 1451. Most of light emitted from each LED module 1010 reaches the outer surface 1451 of a closer one of the light diffusers 1450 where it is reflected off the outer surface 1451 to be scattered in various directions.

Each light diffuser 1450 is disposed in the axially central section of the outer tube 430 and in a state being supported by one of the supports 470. Preferably, the center O of each light diffuser 1450 is located within the axially central section of the outer tube 430, and more preferably each light diffuser 1450 is located entirely within the axially central section of the outer tube 430. Note, in addition, that the number of supports 470 supporting each light diffuser 1450 is not limited to one, and two or more supports may be used. In addition, the light diffusers 1450 may be supported by one or more supports that are different from the supports 470 supporting the circuit unit 440.

The outer surface 1451 of each light diffuser 1450 has an engaging groove 1452 extending along the lamp axis Z. The engaging groove 1452 is for receiving a corresponding one of the supports 470. Each light diffuser 1450 is supported by a different one of the supports 470, by fitting part of the support 470 into the engaging groove 1452 of the light diffuser 1450, followed by securing with adhesive. Note that the method for fixing the circuit unit 1450 to the supports 470 is not limited to the bonding described above, and screws or an engaging mechanic may be used.

The light diffusers 1450 are supported by the supports 470 in the substantially same manner as the light diffuser 1450 according to the first invention. It is applicable to employ thick wires as the wiring lines 444-447 so as allow the supports 470 to be omitted by using the wiring lines 444-447 to support the circuit unit 440 as well as the light diffuser 1450.

[Path of Light Emitted from LEDs]

According to the present embodiment, light emitted from the respective LED modules 1410 toward the circuit unit 440 reaches the nearest one of the light diffusers 1450 and emitted radially and uniformly from the entire outer surface 1451 after wavelength conversion. Since the resulting light emerges radially from the respective light diffusers 1450 as if the light were actually emitted from the light diffusers 1450, the light distribution similar to that of an HID lamp is obtained. Especially notable is that light emitted from the respective LED modules 1410 travel toward each of the two light diffusers 1450 from mutually opposite directions along the lamp axis Z, so that the light diffusers 1450 emit light sufficiently and evenly in both directions along the lamp axis Z.

### [Heat Dissipation Path]

According to the present embodiment, the circuit unit 440 is not located between the base 460 and either of the LED modules 1410. Therefore, similarly to the light source device 1001 according to the first embodiment of the second invention, heat load to be imposed on the circuit unit 440 is kept small. This construction permits a greater number of LEDs 1412 to be included or a higher electric current to be input. In addition, it is not necessary to provide heat dissipating means, such as a heat sink, which is advantageous for avoiding upsizing of the light source device 1400. In addition, the mount 420 of a smaller size may be usable.

### <Modifications>

Up to this point, the light source devices according to the present invention have been specifically described by way of the first to fifth embodiments of the second invention. However, the light source devices according to the present invention are not limited to those according to the first to fight embodiments of the second invention. For example, a light source device constructed by combining parts of the light source devices according to the first to fifth embodiments of the second invention may still fall within the scope of the present invention. In addition, the specific materials, values, and the like mentioned above are merely preferable examples and not to be construed as limiting. Various modifications may be made as appropriate without departing from the technical concepts of the present invention.

The descriptions of the first to fifth embodiments of the second invention are directed to a manner in which LEDs are used as semiconductor light-emitting elements. Alternatively, however, the semiconductor light-emitting elements may be LDs (laser diodes) or electroluminescence (EL) elements.

Still further, the following modifications are possible.

### [Light Diffusion by Light Diffuser]

According to the above embodiments, the light diffusers are those that convert blue light into yellow light. Alternatively, however, the light diffuser may convert ultraviolet light into visible light, such as white light, or may convert visible light other than blue light into a different color of visible light. In addition, the semiconductor light-emitting elements are not limited to those converting only part of emission light into different wavelengths. The semiconductor light-emitting elements may convert the entire emission light into different wavelengths.

When a light diffuser converting ultraviolet light into white light is employed, an LED module that emits ultraviolet light is used. For example, such an LED module includes LEDs that emit ultraviolet light instead of blue light and also includes a colorless transparent sealant that is made of a transparent material not containing a wavelength converting material. In addition, as the light diffuser, one made of a transparent material containing red, green, and blue phosphor particles (wavelength converting material) is used. Since the phosphor particles of the respective colors convert ultraviolet light into light of the respective colors of red, green, and blue, white light is produced as a result of mixture of these colors of light. That is, the light diffuser converts ultraviolet light into white light.

In addition, according to the above embodiments, the entire light diffuser has a wave conversion function. However, it is not necessary, that the entire light diffuser is made of a material containing a wavelength converting material. That is, it is applicable that part of the light diffuser is made of a material not containing a wavelength converting material.

### [Supplemental]

With respect to the LED module, outer tube circuit unit, power connector, and heat pipe, similar modifications as those described in the first invention may be applicable.

### INDUSTRIAL APPLICABILITY

The light source devices according to the present invention are suitable replacements for an HID lamp.

### REFERENCE SIGNS LIST

1, 100, 200, 300, 400, 500, 1001, 1100, 1200, 1300, 1400 Light source device
2, 401 Envelope
12, 412, 1012, 1412 Semiconductor light-emitting element
20, 420 Mount
30, 430 Outer tube
40, 440 Circuit Unit
44-47, 444-447 Electrical wiring line
50, 350, 450, 550, 1050, 1150, 1450 Light Diffuser
51, 351, 451, 551, 1051, 1151, 1451 Outer surface
60, 460 Power connector
70, 470, 570 Support
101 Lens
201, 301 Concave reflecting mirror
202, 302 Reflective surface

1. A light source device including: a semiconductor light-emitting element as a light source; a circuit unit driving the semiconductor light-emitting element to emit light; and an envelope formed from an outer tube and a power connector, the semiconductor light-emitting element and the circuit unit being housed in the envelope, the light source device comprising:
a light diffuser having a reflective outer surface to diffuse incident light; and
one or more supports, wherein
the light diffuser is disposed at least partially in an axially central section of the outer tube,
the semiconductor light-emitting element is disposed on a side of the light diffuser at which the power connector is located and in an orientation that a main emission direction points toward the light diffuser,
at least one component of the circuit unit is disposed on a side of the light diffuser opposite the semiconductor light-emitting element, and
the at least one component of the circuit unit and the light diffuser are held in place by being supported commonly or separately by the one or more supports.

2. The light source device according to claim 1, wherein
an outer shape of the light diffuser is regular polyhedral, semi-regular polyhedral, quasi-regular polyhedral, or spherical.

3. The light source device according to claim 1, further comprising:
a lens disposed between the semiconductor light-emitting element and the light diffuser so as to collect light emitted from the semiconductor light-emitting element to the light diffuser.

4. The light source device according to claim 1, further comprising:
a concave reflecting mirror disposed between the semiconductor light-emitting element and the power connector, the concave reflecting mirror having a concave reflective surface that faces toward the light diffuser and collects light emitted from the semiconductor light-emitting element to the light diffuser.

5. The light source device according to claim 1, further comprising:
a concave reflecting mirror disposed between the light diffuser and the at least one component of the circuit unit, the concave reflecting mirror having a concave reflective surface that faces toward the light diffuser and collects light emitted from the semiconductor light-emitting element to the light diffuser.

6. The light source device according to claim 1, further comprising:
a mount on which the semiconductor light-emitting element is mounted is disposed at an open end of the power connector; and
electrical wiring lines, one of which connects the semiconductor light-emitting element to the at least one component of the circuit unit and another of which connects the power connector to the at least one component of the circuit unit, wherein
each of the one or more supports is a tubular body having one end fixed to the mount, and
each electrical wiring line passes through an interior passage of the one or more supports.

7. The light source device according to claim 1, wherein
the at least one component of the circuit unit is disposed on the side of the light diffuser opposite the semiconductor light-emitting element, and all other components of the circuit unit are disposed between the power connector and the semiconductor light-emitting element.

8. A light source device including: two sets of one or more semiconductor light-emitting elements as a light source; a circuit unit driving the semiconductor light-emitting elements to emit light; and an envelope formed from an outer tube having two open ends and a pair of power connectors attached to each open end of the outer tube, the semiconductor light-emitting elements and the circuit unit being housed in the envelope, the light source device comprising:
two light diffusers each having a reflective outer surface to diffuse incident light; and
one or more supports, wherein
the light diffusers are disposed along an axial direction of the outer tube and both at least partially in an axially central section of the outer tube,
each set of one or more semiconductor light-emitting elements is disposed between one of the light diffusers and one of the power connectors that is closer to the light diffuser, and each semiconductor light-emitting element in the respective sets is oriented so that a main emission direction points toward the light diffuser,
at least one component of the circuit unit is disposed between the two light diffusers, and
the at least one component of the circuit unit and the light diffusers are held in place by being supported commonly or separately by the one or more supports.

9. The light source device according to claim 8, wherein
the at least one component of the circuit unit is disposed between the two light diffusers, and all other components of the circuit unit are disposed between one of the power connectors and the set of semiconductor light-emitting elements that is closer to the power connector.

10. A light source device including: two sets of one or more semiconductor light-emitting elements as a light source; a circuit unit driving the semiconductor light-emitting elements to emit light; and an envelope formed from an outer tube having two open ends and a pair of power connectors attached to each open end of the outer tube, the semiconductor light-emitting elements and the circuit unit being housed in the envelope, the light source device comprising:
a light diffuser having a reflective outer surface to diffuse incident light; and
a support, wherein
at least one component of the circuit unit is disposed inside the light diffuser,
the light diffuser is disposed at least partially in an axially central section of the outer tube,
the sets of one or more semiconductor light-emitting elements are disposed along an axial direction of the outer tube to have the light diffuser therebetween, and each semiconductor light-emitting element in the respective sets is oriented so that a main emission direction points toward the light diffuser, and
the light diffuser is held in place by being supported by the support.

11. The light source device according to claim 10, wherein
the at least one component of the circuit unit is disposed inside the light diffuser, and all other components of the circuit unit are disposed between one of the power connectors and the semiconductor light-emitting element that is closer to the power connector.

12. A light source device including: a semiconductor light-emitting element as a light source; a circuit unit driving the semiconductor light-emitting element to emit light; and an envelope formed from an outer tube and a power connector, the semiconductor light-emitting element and the circuit unit being housed in the envelope, the light source device comprising:
a light diffuser that is a block of a material containing a wavelength converting material, the light diffuser converting incident light into light of a different wavelength and radially diffusing light resulting from the wavelength conversion; and
one or more supports, wherein
the light diffuser is disposed at least partially in an axially central section of the outer tube,
the semiconductor light-emitting element is disposed on a side of the light diffuser at which the power connector is located and in an orientation that a main emission direction points toward the light diffuser,
at least one component of the circuit unit is disposed on the side of the light diffuser opposite the semiconductor light-emitting element, and
the at least one component of the circuit unit and the light diffuser are held in place by being supported commonly or separately by the one or more supports.

13. The light source device according to claim 12, wherein
the light diffuser is solid and has a spherical outer shape.

14. The light source device according to claim 12, further comprising:
a lens disposed between the semiconductor light-emitting element and the light diffuser so as to collect light emitted from the semiconductor light-emitting element to the light diffuser.

15. The light source device according to claim 12, further comprising:
a concave reflecting mirror disposed between the semiconductor light-emitting element and the power connector, the concave reflecting mirror having a concave reflective surface that faces toward the light diffuser and collects light emitted from the semiconductor light-emitting element to the light diffuser.

16. The light source device according to claim 12, further comprising:
a concave reflecting mirror disposed between the light diffuser and the at least one component of the circuit unit, the concave reflecting mirror having a concave reflective surface that faces toward the light diffuser and collects light emitted from the semiconductor light-emitting element to the light diffuser.

17. The light source device according to claim 12, further comprising:
a mount on which the semiconductor light-emitting element is mounted is disposed at an open end of the power connector; and
electrical wiring lines, one of which connects the semiconductor light-emitting element to the at least one component of the circuit unit and another of which connects the power connector to the at least one component of the circuit unit, wherein
each of the one or more supports is a tubular body having one end fixed to the mount, and
each electrical wiring line passes through an interior passage of the one or more supports.

18. The light source device according to claim 12, wherein
the at least one component of the circuit unit is disposed on the side of the light diffuser opposite the semiconductor light-emitting element, and all other components of the circuit unit are disposed between the power connector and the semiconductor light-emitting element.

19. A light source device including: two sets of one or more semiconductor light-emitting elements as a light source; a circuit unit driving the semiconductor light-emitting elements to emit light; and an envelope formed from an outer tube having two open ends and a pair of power connectors attached to each open end of the outer tube, the semiconductor light-emitting elements and the circuit unit being housed in the envelope, the light source device comprising:
two light diffusers each of which is a block of a material containing a wavelength converting material, each light diffuser converting incident light into light of a different wavelength and radially diffusing light resulting from the wavelength conversion; and
one or more supports, wherein
the light diffusers are disposed along an axial direction of the tube and both in an axially central section of the outer tube,
each set of one or more semiconductor light-emitting elements is disposed between one of the light diffusers and one of the power connectors that is closer to the light diffuser, and each semiconductor light-emitting element in the respective sets is oriented so that a main emission direction points toward the light diffuser,
at least one component of the circuit unit is disposed between the two light diffusers, and
the at least one component of the circuit unit and the light diffusers are held in place by being supported commonly or separately by the one or more supports.

20. The light source device according to claim 19, wherein
the at least one component of the circuit unit is disposed between the two light diffusers, and all other components of the circuit unit are disposed between one of the power connectors and the set of semiconductor light-emitting elements that is closer to the power connector.
